(19) United States
(12) Patent Application Publication
(10) Pub. No.: US 2014/0004022 A1
(43) Pub. Date: Jan. 2, 2014

(54) PECVD COATING OF CHROMATOGRAPHY VIALS

(71) Applicant: SiO2 Medical Products, Inc., Auburn, AL (US)

(72) Inventors: Peter J. Sagona, Pottstown, PA (US); Jason Breaux, Auburn, AL (US)

(73) Assignee: SiO2 Medical Products, Inc., Auburn, AL (US)

(21) Appl. No.: 14/015,820

(22) Filed: Aug. 30, 2013

Related U.S. Application Data
(63) Continuation-in-part of application No. 13/941,154, filed on Jul. 12, 2013.
Application No. 13/941,154 is a division of application No. 13/169,811, filed on Jun. 27, 2011, now Pat. No. 8,512,796.
Application No. 13/169,811 is a division of application No. 12/779,007, filed on May 12, 2010, now Pat. No. 7,985,188.
Application No. 12/779,007 is a continuation-in-part of application No. 13/651,299, filed on Oct. 12, 2012.
Application No. 13/651,299 is a continuation-in-part of application No. 13/169,811, filed on Jun. 27, 2011, now Pat. No. 8,512,796.
(60) Provisional application No. 61/333,625, filed on May 11, 2010.
(60) Provisional application No. 61/318,197, filed on Mar. 26, 2010.
(60) Provisional application No. 61/299,888, filed on Jan. 29, 2010.
(60) Provisional application No. 61/298,159, filed on Jan. 25, 2010.
(60) Provisional application No. 61/285,813, filed on Dec. 11, 2009.
(60) Provisional application No. 61/263,289, filed on Nov. 20, 2009.
(60) Provisional application No. 61/261,321, filed on Nov. 14, 2009.
(60) Provisional application No. 61/234,505, filed on Aug. 17, 2009.
(60) Provisional application No. 61/213,904, filed on Jul. 24, 2009.
(60) Provisional application No. 61/222,727, filed on Jul. 2, 2009.
(60) Provisional application No. 61/636,377, filed on Apr. 20, 2012.

(51) Int. Cl. B01L 3/00

(52) U.S. Cl. CPC B01L 3/508
USPC 422/558; 427/579

(57) ABSTRACT

A chromatography vial is disclosed comprising a thermoplastic wall and a coating on the wall. The coating comprises a PECVD barrier coating or layer of SiOₓ, where x is from 1.5 to 2.9, on the interior surface of the vial wall. Also disclosed is a method of applying the barrier coating of SiOₓ, in which x is from about 1.5 to about 2.9, on a chromatography vial as identified above. Other functional layers, such as a pH protective layer and a tie layer, can also be included as part of the coating on the wall.

### CROSS-REFERENCE TO RELATED APPLICATIONS

This application is a continuation in part of:
U.S. Ser. No. 13/941,154, filed Jul. 12, 2013, which is a divisional of
U.S. Ser. No. 13/169,811, filed Jun. 27, 2011, now U.S. Pat. No. 8,512,796, which is a divisional of
U.S. Ser. No. 12/779,007, filed May 12, 2010, now U.S. Pat. No. 7,985,188, which claims priority to each of:
U.S. Provisional Ser. No. 61/333,625, filed May 11, 2010;
U.S. Provisional Ser. No. 61/318,197, filed Mar. 26, 2010;
U.S. Provisional Ser. No. 61/299,888, filed Jan. 29, 2010;
U.S. Provisional Ser. No. 61/298,159, filed Jan. 25, 2010;
U.S. Provisional Ser. No. 61/285,813, filed Dec. 11, 2009;
U.S. Provisional Ser. No. 61/263,289, filed Nov. 20, 2009;
U.S. Provisional Ser. No. 61/261,321, filed Nov. 14, 2009;
U.S. Provisional Ser. No. 61/234,505, filed Aug. 17, 2009;
U.S. Provisional Ser. No. 61/213,904, filed Jul. 24, 2009; and
U.S. Provisional Ser. No. 61/222,727, filed Jul. 2, 2009.
   This application also is a continuation-in-part of:
U.S. Ser. No. 13/651,299, filed Oct. 12, 2012, now pending, which is a continuation in part of
U.S. Ser. No. 13/169,811, filed Jun. 27, 2011, now U.S. Pat. No. 8,512,796.
   U.S. Ser. No. 13/651,299 also claims priority to
U.S. Provisional Ser. No. 61/636,377, filed Apr. 20, 2012.

Each application identified above is incorporated by reference as a whole in this application to provide continuity of disclosure.

### TECHNICAL FIELD

This invention relates generally to thermoplastic vials used to contain samples for chromatography chemical analysis, commonly known as chromatography vials, and more particularly to chromatography vials that have a treated interior surface to minimize interaction between the vial wall and a sample contained in the vial.

### BACKGROUND OF THE INVENTION

Chromatography vials are commonly used in large numbers to contain chemical and biological samples for analysis. The vials are used to receive and store samples, as well as to transport the samples through automated sampling equipment that withdraws a sample from each vessel for introduction into an analytical instrument.

Particularly when such automated sampling equipment is used, it is important that the vessels have highly uniform dimensions, to prevent misfeeding and disorientation of the vessels (leading to mechanical problems, missed or inaccurate sampling, and other difficulties). It is also important that the vessels be as free as possible from particles that may contaminate the sample, and that the vessel wall not interact with the samples, as by degrading the sample or contaminating the sample with foreign constituents extracted by the sample from the vial wall.

Prior chromatography vials have been made of glass or plastic. In some instances, plastic vials have been provided with glass inserts that contact the sample. Dimensional tolerances for glass vials are more difficult to maintain, at times resulting in autoinjector issues, including jamming and breakage of glass vials. Glass vials also inherently contain particles (for example of glass or glass consituents), have heavy metal extractables, and can cause aggregation of proteins and other biologics. Plastic vials can cause non-specific binding of biologics and contain leachables that limit their use for sensitive tests. Plastic vials with glass inserts have the same issues as glass vials, apart from the dimensional issue.

In addition, there have been a number of techniques to improve the surface characteristics and cleanliness of vials used for chromatography. These include acid washes, salinization and the use of organosilane in a gas phase to ostensibly reduce protein binding. However there is limited data on the effect and consistency/repeatability of these techniques.

U.S. Pat. Publ. 2010/0298738 (the publication of U.S. Ser. No. 12/779,007), which is incorporated here by reference in its entirety and not admitted to be prior art, states at Paragraph 0339, “The PECVD coating methods, etc., described in this specification are also useful for coating vials to form a coating, for example a barrier layer or a hydrophobic layer, or a combination of these layers. A vial is a small vessel or bottle, especially used to store medication as liquids, powders or lyophilized powders. They can also be sample vessels e.g. for use in autosampler devices in analytical chromatography. A vial can have a tubular shape or a bottle-like shape with a neck. The bottom is usually flat unlike test tubes or sample collection tubes which usually have a rounded bottom. Vials can be made, for example, of plastic (e.g. polypropylene, COC, COP).

### SUMMARY OF THE INVENTION

One aspect of the invention is a chromatography vial comprising a thermoplastic wall 12 and a coating on the wall 12. The thermoplastic wall 12 has an interior surface defining a sample containment lumen. The coating comprises a PECVD barrier coating or layer of SiOₓ, where x is from 1.5 to 2.9, on the interior surface of the vial wall 12. While the invention is not limited by any specific advantages, one of the following advantages may be realized, at least to some degree, by practicing the invention:
Reduced non-specific binding of peptides and proteins
Reduced aggregation of protein based products
Substantial reduction of metal contaminants
Enhanced solvent resistance and minimized extractable compounds
Improved vial cleanliness and reduced particulates.

Another aspect of the invention is a method of applying a barrier coating of SiOₓ, in which x is from about 1.5 to about 2.9, on a chromatography vial as identified above. The method can be carried out as follows.

A chromatography vial is provided, having a thermoplastic wall with an interior surface defining a sample containment lumen. A reaction mixture is provided that includes a precursor gas, for example an organosilicon compound gas. The reaction mixture optionally includes an oxidizing gas, optionally includes a carrier or diluent gas, and optionally includes a hydrocarbon gas. A plasma is formed in the reaction mixture by energizing the vicinity of the precursor with electrodes supplied with electric power at equal to or more than 5 W/ml. of plasma volume. The interior surface of the chromatography vial is contacted with the reaction mixture, and a coating of SiOₓ is deposited on at least a portion of the interior surface of the chromatography vial.

### BRIEF DESCRIPTION OF DRAWING FIGURES

FIG. 1 is a diagrammatic longitudinal section of a chromatography vial according to an embodiment of the present invention.

FIG. 2 is a schematic diagram of a PECVD coating apparatus used to carry out an embodiment of the present invention.

The following reference characters are used in this description.

| | |
|---|---|
| 10 | Chromatography vial |
| 12 | Thermoplastic wall |
| 14 | Closure |
| 16 | Interior surface |
| 18 | Coating |
| 20 | Sample containment lumen |
| 28 | Coating station |
| 50 | Vessel holder |
| 98 | Vacuum source |
| 108 | Probe (counter electrode) |
| 110 | Gas delivery port (of 108) |
| 144 | PECVD gas source |
| 152 | Pressure gauge |
| 160 | Electrode |
| 162 | Power supply |
| 168 | Closed end (of 160) |
| 404 | Vent |
| 574 | Main vacuum valve |
| 576 | Vacuum line |
| 578 | Manual bypass valve |
| 580 | Bypass line |
| 582 | Vent valve |
| 584 | Main reactant gas valve |
| 586 | Main reactant feed line |
| 588 | Organosilicon liquid reservoir |
| 590 | Organosilicon feed line (capillary) |
| 592 | Organosilicon shut-off valve |
| 594 | Oxygen tank |
| 596 | Oxygen feed line |
| 598 | Mass flow controller |
| 600 | Oxygen shut-off valve |
| 602 | Source of carrier gas |
| 604 | Conduit |
| 606 | Carrier gas shut-off valve |
| 614 | Headspace |
| 616 | Pressure source |
| 618 | Pressure line |
| 620 | Capillary connection |

In the context of the present invention, the following definitions and abbreviations are used:

RF is radio frequency.

The term “at least” in the context of the present invention means “equal or more” than the integer following the term. The word “comprising” does not exclude other elements or steps, and the indefinite article “a” or “an” does not exclude a plurality unless indicated otherwise. Whenever a parameter range is indicated, it is intended to disclose the parameter values given as limits of the range and all values of the parameter falling within said range.

“First” and “second” or similar references to, for example, deposits of lubricant, processing stations or processing devices refer to the minimum number of deposits, processing stations or devices that are present, but do not necessarily represent the order or total number of deposits, processing stations and devices or require additional deposits, processing stations and devices beyond the stated number. These terms do not limit the number of processing stations or the particular processing carried out at the respective stations. For example, a “first” deposit in the context of this specification can be either the only deposit or any one of plural deposits, without limitation. In other words, recitation of a “first” deposit allows but does not require an embodiment that also has a second or further deposit.

For purposes of the present invention, an “organosilicon precursor” is a compound having at least one of the linkages:

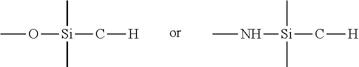

which is a tetravalent silicon atom connected to an oxygen or nitrogen atom and an organic carbon atom (an organic carbon atom being a carbon atom bonded to at least one hydrogen atom). A volatile organosilicon precursor, defined as such a precursor that can be supplied as a vapor in a PECVD apparatus, is an optional organosilicon precursor. Optionally, the organosilicon precursor is selected from the group consisting of a linear siloxane, a monocyclic siloxane, a polycyclic siloxane, a polysilsesquioxane, an alkyl trimethoxysilane, a linear silazane, a monocyclic silazane, a polycyclic silazane, a polysilsesquiazane, and a combination of any two or more of these precursors.

The feed amounts of PECVD precursors, gaseous reactant or process gases, and carrier gas are sometimes expressed in “standard volumes” in the specification and claims. The standard volume of a charge or other fixed amount of gas is the volume the fixed amount of the gas would occupy at a standard temperature and pressure (without regard to the actual temperature and pressure of delivery). Standard volumes can be measured using different units of volume, and still be within the scope of the present disclosure and claims. For example, the same fixed amount of gas could be expressed as the number of standard cubic centimeters, the number of standard cubic meters, or the number of standard cubic feet. Standard volumes can also be defined using different standard temperatures and pressures, and still be within the scope of the present disclosure and claims. For example, the standard temperature might be 0° C. and the standard pressure might be 760 Torr (as is conventional), or the standard temperature might be 20° C. and the standard pressure might be 1 Torr. But whatever standard is used in a given case, when comparing relative amounts of two or more different gases without specifying particular parameters, the same units of volume, standard temperature, and standard pressure are to be used relative to each gas, unless otherwise indicated.

The corresponding feed rates of PECVD precursors, gaseous reactant or process gases, and carrier gas are expressed in standard volumes per unit of time in the specification. For example, in the working examples the flow rates are expressed as standard cubic centimeters per minute, abbreviated as sccm. As with the other parameters, other units of time can be used, such as seconds or hours, but consistent parameters are to be used when comparing the flow rates of two or more gases, unless otherwise indicated.

A “vessel” in the context of the present invention can be any type of vessel with at least one opening and a wall defining an inner or interior surface. The substrate can be the wall of a vessel having a lumen. Though the invention is not necessarily limited to pharmaceutical packages or other vessels of a particular volume, pharmaceutical packages or other vessels are contemplated in which the lumen has a void volume of from 0.5 to 50 mL, optionally from 1 to 10 mL, optionally from 0.5 to 5 mL, optionally from 1 to 3 mL. The substrate surface can be part or all of the inner or interior surface of a vessel having at least one opening and an inner or interior surface. Some examples of a pharmaceutical package include, but are not limited to, a vial, a plastic-coated vial, a syringe, a plastic coated syringe, a blister pack, an ampoule, a plastic coated ampoule, a cartridge, a bottle, a plastic coated bottle, a pouch, a pump, a sprayer, a stopper, a needle, a plunger, a cap, a stent, a catheter or an implant.

The term “at least” in the context of the present invention means “equal or more” than the integer following the term. Thus, a vessel in the context of the present invention has one or more openings. One or two openings, like the openings of a sample tube (one opening) or a syringe barrel (two openings) are preferred. If the vessel has two openings, they can be of same or different size. If there is more than one opening, one opening can be used for the gas inlet for a PECVD coating method according to the present invention, while the other openings are either capped or open. A vessel according to the present invention can be a sample tube, for example for collecting or storing biological fluids like blood or urine, a syringe (or a part thereof, for example a syringe barrel) for storing or delivering a biologically active compound or composition, for example a medicament or pharmaceutical composition, a vial for storing biological materials or biologically active compounds or compositions, a pipe, for example a catheter for transporting biological materials or biologically active compounds or compositions, or a cuvette for holding fluids, for example for holding biological materials or biologically active compounds or compositions.

A vessel can be of any shape, a vessel having a substantially cylindrical wall adjacent to at least one of its open ends being preferred. Generally, the interior wall of the vessel is cylindrically shaped, like, for example in a sample tube or a syringe barrel. Sample tubes and syringes or their parts (for example syringe barrels) are contemplated.

A “hydrophobic layer” in the context of the present invention means that the coating or layer lowers the wetting tension of a surface coated with the coating or layer, compared to the corresponding uncoated surface. Hydrophobicity is thus a function of both the uncoated substrate and the coating or layer. The same applies with appropriate alterations for other contexts wherein the term “hydrophobic” is used. The term “hydrophilic” means the opposite, i.e. that the wetting tension is increased compared to reference sample. The present hydrophobic layers are primarily defined by their hydrophobicity and the process conditions providing hydrophobicity

These values of w, x, y, and z are applicable to the empirical composition Si_{w}OₓC_{y}H_{z} throughout this specification. The values of w, x, y, and z used throughout this specification should be understood as ratios or an empirical formula (for example for a coating or layer), rather than as a limit on the number or type of atoms in a molecule. For example, octamethylcyclotetrasiloxane, which has the molecular composition Si₄O₄C₈H₂₄, can be described by the following empirical formula, arrived at by dividing each of w, x, y, and z in the molecular formula by 4, the largest common factor: Si₁O₁C₂H₆. The values of w, x, y, and z are also not limited to integers. For example, (acyclic) octamethyltrisiloxane, molecular composition Si₃O₂C₈H₂₄, is reducible to Si₁O_{0.67}C_{2.67}H₈. Also, although SiOₓC_{y}H_{z} is described as equivalent to SiOₓC_{y}, it is not necessary to show the presence of hydrogen in any proportion to show the presence of SiOₓC_{y}.

“Wetting tension” is a specific measure for the hydrophobicity or hydrophilicity of a surface. An optional wetting tension measurement method in the context of the present invention is ASTM D 2578 or a modification of the method described in ASTM D 2578. This method uses standard wetting tension solutions (called dyne solutions) to determine the solution that comes nearest to wetting a plastic film surface for exactly two seconds. This is the film's wetting tension. The procedure utilized is varied herein from ASTM D 2578 in that the substrates are not flat plastic films, but are tubes made according to the Protocol for Forming PET Tube and (except for controls) coated according to the Protocol for coating Tube Interior with Hydrophobic Coating or Layer (see Example 9 of EP2251671 A2).

The atomic ratio can be determined by XPS. Taking into account the H atoms, which are not measured by XPS, the coating or layer may thus in one aspect have the formula SiOₓC_{y}H_{z} (or its equivalent SiOₓC_{y}), for example where w is 1, x is from about 0.5 to about 2.4, y is from about 0.6 to about 3, and z is from about 2 to about 9. Typically, such coating or layer would hence contain 36% to 41% carbon normalized to 100% carbon plus oxygen plus silicon.

A coating or layer or treatment is defined as “hydrophobic” if it lowers the wetting tension of a surface, compared to the corresponding uncoated or untreated surface. Hydrophobicity is thus a function of both the untreated substrate and the treatment.

“Primer” coating or layer—another name for the pH protective layer or barrier layer when used to receive a deposit of silicone oil as a lubricant.

The word “comprising” does not exclude other elements or steps

The indefinite article “a” or “an” does not exclude a plurality.

### DETAILED DESCRIPTION

One aspect of the disclosure is a chromatography vial 10 comprising a thermoplastic wall 12 and a coating 18 on the wall 12. A thermoplastic wall has many advantages. A thermoplastic wall in contact with the sample is preferred in the biologics area, for example, due to the large number of issues with glass vials.

The thermoplastic wall 12 has an interior surface 16 defining a sample containment lumen 20. The coating 18 comprises a PECVD barrier coating or layer of SiOₓ, where x is from 1.5 to 2.9, on the interior surface 16 of the vial wall 12. Optionally, the chromatography vial 10 can have a closure 14, which can be a screw cap, a crimp closure, a septum, or any other suitable closure.

Optionally in any embodiment of the disclosure, the chromatography vial is configured for liquid chromatography (LC) samples, for example high pressure liquid chromatography (HPLC), LC, ultra high pressure liquid chromatography (UHPLC), ultra performance liquid chromatography (UPLC), gas chromatography, Ion-exchanged chromatography, supercritical flow chromatography, or a combination of any two or more of these.

### Thermoplastic Wall

Optionally in any embodiment of the disclosure, the wall comprises a polycarbonate, an olefin polymer (for example polypropylene (PP) or polyethylene (PE)), a cyclic olefin copolymer (COC), a cyclic olefin polymer (COP), polymethylpentene, a polyester (for example polyethylene terephthalate, polyethylene naphthalate, or polybutylene terephthalate (PBT)), PVdC (polyvinylidene chloride), polyvinyl chloride (PVC), polycarbonate, polylactic acid, polystyrene, hydrogenated polystyrene, poly(cyclohexylethylene) (PCHE), epoxy resin, nylon, polyurethane polyacrylonitrile (PAN), polyacrylonitrile (PAN), an ionomeric resin (for example Surlyn®), glass (for example borosilicate glass), or a combination of any two or more of these; preferably comprises a cyclic olefin polymer, a polyethylene terephthalate or a polypropylene; and more preferably comprises COP.

Optionally in any embodiment of the disclosure, at least a portion of the wall of the vial comprises: a polyolefin, a polyester, or a combination of a polyolefin and a polyester.

Optionally in any embodiment of the disclosure, at least a portion of the wall of the vial comprises a polyolefin.

Optionally in any embodiment of the disclosure, at least a portion of the wall of the vial consists essentially of a polyolefin.

Optionally in any embodiment of the disclosure, at least a portion of the wall of the vial comprises a cyclic olefin polymer.

Optionally in any embodiment of the disclosure, at least a portion of the wall of the vial consists essentially of a cyclic olefin polymer.

Optionally in any embodiment of the disclosure, at least a portion of the wall of the vial comprises a cyclic olefin copolymer.

Optionally in any embodiment of the disclosure, at least a portion of the wall of the vial consists essentially of a cyclic olefin copolymer.

Optionally in any embodiment of the disclosure, at least a portion of the wall of the vial comprises polypropylene.

Optionally in any embodiment of the disclosure, at least a portion of the wall of the vial consists essentially of polypropylene.

Optionally in any embodiment of the disclosure, at least a portion of the wall of the vial comprises a polyester.

Optionally in any embodiment of the disclosure, at least a portion of the wall of the vial consists essentially of a polyester.

Optionally in any embodiment of the disclosure, at least a portion of the wall of the vial comprises polyethylene terephthalate.

Optionally in any embodiment of the disclosure, at least a portion of the wall of the vial consists essentially of polyethylene terephthalate.

### Barrier Coating or Layer

Optionally in any embodiment of the disclosure, the PECVD coating or layer of SiOₓ is effective to reduce non-specific binding of a peptide on the interior surface.

Optionally in any embodiment of the disclosure, the PECVD coating or layer of SiOₓ is effective to reduce non-specific binding of a protein on the interior surface.

Optionally in any embodiment of the disclosure, the PECVD coating or layer of SiOₓ is effective to reduce the quantity of extraction of at least one extractable compound in the thermoplastic wall.

Optionally in any embodiment of the disclosure, the barrier coating or layer is on average from 4 nm to 500 nm thick, alternatively from 7 nm to 400 nm thick, alternatively from 10 nm to 300 nm thick, alternatively between 10 and 200 nm thick, alternatively between 10 and 100 nm thick alternatively from 20 nm to 200 nm thick, alternatively from 30 nm to 100 nm thick.

### pH Protective Coating or Layer

Optionally in any embodiment of the disclosure, the coating (18) further comprises a pH protective coating or layer comprising SiOₓC_{y} or SiNₓC_{y}, wherein x is from about 0.5 to about 2.4 and y is from about 0.6 to about 3, between the barrier coating or layer and the lumen.

Detailed information about the pH protective layer is found in WO2013/071138, and is incorporated here by reference.

Optionally in any embodiment of the disclosure, the rate of erosion of the pH protective coating or layer, if directly contacted by a fluid composition having a pH at some point between 5 and 9, is less than the rate of erosion of the barrier coating or layer, if directly contacted by the fluid composition.

Optionally in any embodiment of the disclosure, the fluid composition has a pH between 5 and 9, alternatively between 5 and 6, alternatively between 6 and 7, alternatively between 7 and 8, alternatively between 8 and 9, alternatively between 6.5 and 7.5, alternatively between 7.5 and 8.5, alternatively between 8.5 and 9.

Optionally in any embodiment of the disclosure, the fluid composition is a liquid at 20° C. and 760 mm Hg. atmospheric pressure.

Optionally in any embodiment of the disclosure, the fluid composition is an aqueous liquid.

Optionally in any embodiment of the disclosure, the pH protective coating or layer comprises SiOₓC_{y} or consists essentially of SiOₓC_{y}.

Optionally in any embodiment of the disclosure, the pH protective coating or layer comprises SiNₓC_{y} or consists essentially of SiNₓC_{y}.

Optionally in any embodiment of the disclosure, the pH protective coating or layer is applied by PECVD of a precursor feed comprising an acyclic siloxane, a monocyclic siloxane, a polycyclic siloxane, a polysilsesquioxane, a monocyclic silazane, a polycyclic silazane, a polysilsesquiazane, a silatrane, a silquasilatrane, a silproatrane, an azasilatrane, an azasilquasiatrane, an azasilproatrane, or a combination of any two or more of these precursors.

For example, the pH protective coating or layer can be applied by PECVD of a precursor feed comprising or consisting essentially of a monocyclic siloxane, for example octamethylcyclotetrasiloxane (OMCTS).

For another example, the pH protective coating or layer can be applied by PECVD of a precursor feed comprising or consisting essentially of a monocyclic silazane, a polycyclic silazane, a polysilsesquiazane, an azasilatrane, an azasilquasiatrane, an azasilproatrane, or a combination of any two or more of these precursors.

Optionally in any embodiment of the disclosure, the pH protective coating or layer can be applied by PECVD of a precursor feed further comprising oxygen.

Optionally in any embodiment of the disclosure, the pH protective coating or layer can be applied by PECVD of a precursor feed further comprising a carrier gas, also known as a diluent gas. Optionally in any embodiment of the disclosure, the carrier gas, also known as a diluent gas, comprises argon.

Optionally in any embodiment of the disclosure, the precursor feed for the pH protective layer comprises:
from 0.5 to 10 standard volumes of the organosilicon precursor;
from 0.1 to 10 standard volumes of oxygen; and
from 1 to 100 sccm of a carrier gas.

Optionally in any embodiment of the disclosure, the precursor feed for the pH protective layer comprises:
from 0.5 to 10 standard volumes of octamethylenecyclotetrasiloxane;
from 0.1 to 10 standard volumes of oxygen; and
from 1 to 100 sccm of argon.

Optionally in any embodiment of the disclosure, the pH protective coating or layer as applied is between 10 and 1000 nm thick, alternatively between 50 and 800 nm thick, alternatively between 50 and 400 nm thick, alternatively between 50 and 250 nm thick, alternatively between 100 and 700 nm thick, preferably between 300 and 600 nm thick.

Optionally in any embodiment of the disclosure, the pH protective coating or layer contacting the fluid composition is between 10 and 1000 nm thick two years after the coated vial is contacted with a sample comprising a fluid composition.

Optionally in any embodiment of the disclosure, the pH protective coating or layer contacting the fluid composition is between 20 and 700 nm thick, optionally between 50 and 500 nm thick, optionally between 100 and 400 nm thick, optionally between 150 and 300 nm thick two years after the coated vial is contacted with a sample comprising a fluid composition.

Optionally in any embodiment of the disclosure, the rate of erosion of the pH protective coating or layer, if directly contacted by a fluid composition having a pH of 8, is less than 20%, optionally less than 15%, optionally less than 10%, optionally less than 7%, optionally from 5% to 20%, optionally from 5% to 15%, optionally from 5% to 10%, optionally from 5% to 7% of the rate of erosion of the barrier coating or layer, if directly contacted by the same fluid composition under the same conditions.

Optionally in any embodiment of the disclosure, the pH protective coating or layer is at least coextensive with the barrier coating or layer.

Optionally in any embodiment of the disclosure, the chromatography vial 10 has a shelf life, after the coated vial is contacted with a sample comprising a fluid composition, of at least one year, optionally at least two years, optionally at least three years, optionally at least four years, optionally at least five years, optionally at least six years, optionally at least seven years, optionally at least eight years, optionally at least nine years.

Optionally in any embodiment of the disclosure, the chromatography vial 10 has a shelf life, after the coated vial is contacted with a sample comprising a fluid composition, of at most ten years.

Optionally in any embodiment of the disclosure, the shelf life is determined at 3° C., optionally at 20° C., optionally at 23° C., optionally at 40° C.

Optionally in any embodiment of the disclosure, the pH of the fluid composition is between 5 and 6 and the thickness of the pH protective coating or layer is at least 80 nm at the end of the shelf life.

Optionally in any embodiment of the disclosure, the pH of the fluid composition is between 6 and 7 and the thickness of the pH protective coating or layer is at least 80 nm at the end of the shelf life.

Optionally in any embodiment of the disclosure, the pH of the fluid composition is between 7 and 8 and the thickness of the pH protective coating or layer is at least 80 nm at the end of the shelf life.

Optionally in any embodiment of the disclosure, the pH of the fluid composition is between 8 and 9 and the thickness of the pH protective coating or layer is at least 80 nm at the end of the shelf life.

Optionally in any embodiment of the disclosure, the pH of the fluid composition is between 5 and 6 and the thickness of the pH protective coating or layer is at least 150 nm at the end of the shelf life.

Optionally in any embodiment of the disclosure, the pH of the fluid composition is between 6 and 7 and the thickness of the pH protective coating or layer is at least 150 nm at the end of the shelf life.

Optionally in any embodiment of the disclosure, the pH of the fluid composition is between 7 and 8 and the thickness of the pH protective coating or layer is at least 150 nm at the end of the shelf life.

Optionally in any embodiment of the disclosure, the pH of the fluid composition is between 8 and 9 and the thickness of the pH protective coating or layer is at least 150 nm at the end of the shelf life.

Optionally in any embodiment of the disclosure, the fluid composition removes the pH protective coating or layer at a rate of 1 nm or less of pH protective coating or layer thickness per 44 hours of contact with the fluid composition, optionally per 88 hours of contact with the fluid composition, optionally per 175 hours of contact with the fluid composition, optionally per 250 hours of contact with the fluid composition, optionally per 350 hours of contact with the fluid composition.

Optionally in any embodiment of the disclosure, an FTIR absorbance spectrum of the pH protective coating or layer has a ratio greater than 0.75 between:
the maximum amplitude of the Si—O—Si symmetrical stretch peak between about 1000 and 1040 cm-1, and
the maximum amplitude of the Si—O—Si assymmetric stretch peak between about 1060 and about 1100 cm-1.

Optionally, the ratio is at least 0.8, or at least 0.9, or at least 1, or at least 1.1, or at least 1.2. Optionally, the ratio is at most 1.7, or at most 1.6, or at most 1.5, or at most 1.5, or at most 1.4, or at most 1.3.

Optionally in any embodiment of the disclosure, the pH protective coating or layer has a non-oily appearance.

Optionally in any embodiment of the disclosure, the silicon dissolution rate by a 50 mM potassium phosphate buffer diluted in water for injection, adjusted to pH 8 with concentrated nitric acid, and containing 0.2 wt. % polysorbate-80 surfactant from the vial is less than 170 ppb/day, or less than 160 ppb/day, or less than 140 ppb/day, or less than 120 ppb/day, or less than 100 ppb/day, or less than 90 ppb/day, or less than 80 ppb/day.

Optionally in any embodiment of the disclosure, the total silicon content of the pH protective coating or layer and barrier coating or layer, upon dissolution into 0.1 N potassium hydroxide aqueous solution at 40° C. from the vial, is less than 66 ppm, or less than 60 ppm, or less than 50 ppm, or less than 40 ppm, or less than 30 ppm, or less than 20 ppm.

Optionally in any embodiment of the disclosure, the calculated shelf life (total Si/Si dissolution rate) is more than 1 year, or more than 18 months, or more than 2 years, or more than 2½ years, or more than 3 years. Optionally in any embodiment of the disclosure, the calculated shelf life (total Si/Si dissolution rate) is less than 4 years, or less than 5 years.

Optionally in any embodiment of the disclosure, the pH protective coating or layer is applied by PECVD at a power level per of more than 22,000 kJ/kg, or more than 30,000 kJ/kg, or more than 40,000 kJ/kg, or more than 50,000 kJ/kg, or more than 60,000 kJ/kg, or more than 62,000 kJ/kg, or more than 70,000 kJ/kg, or more than 80,000 kJ/kg of mass of polymerizing gases in the PECVD reaction chamber. Optionally in any embodiment of the disclosure, the pH protective coating or layer is applied by PECVD at a power level per of less than 100,000 kJ/kg or less than 90,000 kJ/kg of mass of polymerizing gases in the PECVD reaction chamber.

Optionally in any embodiment of the disclosure, the pH protective coating or layer is applied by PECVD at a power level per of from 0.1 to 500 W, or from 0.1 to 400 W, or from 1 to 250 W, or from 1 to 200 W, or from 10 to 150 W, or from 20 to 150 W, or from 40 to 150 W, or from 60 to 150 W.

Optionally in any embodiment of the disclosure, the ratio of the electrode power to the plasma volume during PECVD for formation of the pH protective coating or layer is from 1 W/ml to 100 W/ml., or from 5 W/ml to 75 W/ml., or from 6 W/ml to 60 W/ml., or from 10 W/ml to 50 W/ml., or from 20 W/ml to 40 W/ml.

Optionally in any embodiment of the disclosure, the pH protective coating or layer has an RMS surface roughness value (measured by AFM) of from about 5 to about 9, or from about 6 to about 8, or from about 4 to about 6, or from about 4.6 to about 5.8.

Optionally in any embodiment of the disclosure, the pH protective coating or layer has an Rmax surface roughness value of the pH protective coating or layer, measured by AFM, from about 70 to about 160, or from about 84 to about 142, or from about 90 to about 130.

The inventors have found that barrier layers or coatings of SiOₓ are eroded or dissolved by some fluids, for example aqueous compositions having a pH above about 5. Since coatings applied by chemical vapor deposition can be very thin—tens to hundreds of nanometers thick—even a relatively slow rate of erosion can remove or reduce the effectiveness of the barrier layer in less time than the desired shelf life of a product package. This is particularly a problem for fluid pharmaceutical compositions, since many of them have a pH of roughly 7, or more broadly in the range of 5 to 9, similar to the pH of blood and other human or animal fluids. The higher the pH of the pharmaceutical preparation, the more quickly it erodes or dissolves the SiOₓ coating. Optionally, this problem can be addressed by protecting the barrier coating or layer 288, or other pH sensitive material, with a pH protective coating or layer 286.

Optionally, the pH protective coating or layer 286 can be composed of, comprise, or consist essentially of Si_{w}OₓC_{y}H_{z} (or its equivalent SiOₓC_{y}) or Si_{w}NₓC_{y}H_{z} or its equivalent SiNₓC_{y}), each as defined previously. The atomic ratio of Si:O:C or Si:N:C can be determined by XPS (X-ray photoelectron spectroscopy). Taking into account the H atoms, the pH protective coating or layer may thus in one aspect have the formula Si_{w}OₓC_{y}H_{z}, or its equivalent SiOₓC_{y}, for example where w is 1, x is from about 0.5 to about 2.4, y is from about 0.6 to about 3, and z is from about 2 to about 9.

Typically, expressed as the formula Si_{w}OₓC_{y}, the atomic ratios of Si, O, and C are, as several options:
Si 100:O 50-150: C 90-200 (i.e. w=1, x=0.5 to 1.5, y=0.9 to 2);
Si 100: O 70-130: C 90-200 (i.e. w=1, x=0.7 to 1.3, y=0.9 to 2)
Si 100: O 80-120: C 90-150 (i.e. w=1, x=0.8 to 1.2, y=0.9 to 1.5)
Si 100: O 90-120: C 90-140 (i.e. w=1, x=0.9 to 1.2, y=0.9 to 1.4)
Si 100: O 92-107: C 116-133 (i.e. w=1, x=0.92 to 1.07, y=1.16 to 1.33), or
Si 100: O 80-130: C 90-150.

Alternatively, the pH protective coating or layer can have atomic concentrations normalized to 100% carbon, oxygen, and silicon, as determined by X-ray photoelectron spectroscopy (XPS) of less than 50% carbon and more than 25% silicon. Alternatively, the atomic concentrations are from 25 to 45% carbon, 25 to 65% silicon, and 10 to 35% oxygen. Alternatively, the atomic concentrations are from 30 to 40% carbon, 32 to 52% silicon, and 20 to 27% oxygen. Alternatively, the atomic concentrations are from 33 to 37% carbon, 37 to 47% silicon, and 22 to 26% oxygen.

The thickness of the pH protective coating or layer can be, for example:
from 10 nm to 1000 nm;
alternatively from 10 nm to 1000 nm;
alternatively from 10 nm to 900 nm;
alternatively from 10 nm to 800 nm;
alternatively from 10 nm to 700 nm;
alternatively from 10 nm to 600 nm;
alternatively from 10 nm to 500 nm;
alternatively from 10 nm to 400 nm;
alternatively from 10 nm to 300 nm;
alternatively from 10 nm to 200 nm;
alternatively from 10 nm to 100 nm;
alternatively from 10 nm to 50 nm;
alternatively from 20 nm to 1000 nm;
alternatively from 50 nm to 1000 nm;
alternatively from 10 nm to 1000 nm;
alternatively from 50 nm to 800 nm;
alternatively from 100 nm to 700 nm;
alternatively from 300 to 600 nm.

Optionally, the atomic concentration of carbon in the protective layer, normalized to 100% of carbon, oxygen, and silicon, as determined by X-ray photoelectron spectroscopy (XPS), can be greater than the atomic concentration of carbon in the atomic formula for the organosilicon precursor. For example, embodiments are contemplated in which the atomic concentration of carbon increases by from 1 to 80 atomic percent, alternatively from 10 to 70 atomic percent, alternatively from 20 to 60 atomic percent, alternatively from 30 to 50 atomic percent, alternatively from 35 to 45 atomic percent, alternatively from 37 to 41 atomic percent.

Optionally, the atomic ratio of carbon to oxygen in the pH protective coating or layer can be increased in comparison to the organosilicon precursor, and/or the atomic ratio of oxygen to silicon can be decreased in comparison to the organosilicon precursor.

Optionally, the pH protective coating or layer can have an atomic concentration of silicon, normalized to 100% of carbon, oxygen, and silicon, as determined by X-ray photoelectron spectroscopy (XPS), less than the atomic concentration of silicon in the atomic formula for the feed gas. For example, embodiments are contemplated in which the atomic concentration of silicon decreases by from 1 to 80 atomic percent, alternatively by from 10 to 70 atomic percent, alternatively by from 20 to 60 atomic percent, alternatively by from 30 to 55 atomic percent, alternatively by from 40 to 50 atomic percent, alternatively by from 42 to 46 atomic percent.

As another option, a pH protective coating or layer is contemplated that can be characterized by a sum formula wherein the atomic ratio C:O can be increased and/or the atomic ratio Si:O can be decreased in comparison to the sum formula of the organosilicon precursor.

The pH protective coating or layer 286 commonly is located between the barrier coating or layer 288 and the fluid 218 in the finished article. The pH protective coating or layer 286 is supported by the thermoplastic wall 214.

The pH protective coating or layer 286 optionally is effective to keep the barrier coating or layer 288 at least substantially undissolved as a result of attack by the fluid 218 for a period of at least six months.

The pH protective coating or layer can have a density between 1.25 and 1.65 g/cm³, alternatively between 1.35 and 1.55 g/cm³, alternatively between 1.4 and 1.5 g/cm³, alternatively between 1.4 and 1.5 g/cm³, alternatively between 1.44 and 1.48 g/cm³, as determined by X-ray reflectivity (XRR). Optionally, the organosilicon compound can be octamethylcyclotetrasiloxane and the pH protective coating or layer can have a density which can be higher than the density of a pH protective coating or layer made from HMDSO as the organosilicon compound under the same PECVD reaction conditions.

The pH protective coating or layer optionally can prevent or reduce the precipitation of a compound or component of a composition in contact with the pH protective coating or layer, in particular can prevent or reduce insulin precipitation or blood clotting, in comparison to the uncoated surface and/or to a barrier coated surface using HMDSO as precursor.

The pH protective coating or layer optionally can have an RMS surface roughness value (measured by AFM) of from about 5 to about 9, optionally from about 6 to about 8, optionally from about 6.4 to about 7.8. The Rₐ surface roughness value of the pH protective coating or layer, measured by AFM, can be from about 4 to about 6, optionally from about 4.6 to about 5.8. The Rₘₐₓ surface roughness value of the pH protective coating or layer, measured by AFM, can be from about 70 to about 160, optionally from about 84 to about 142, optionally from about 90 to about 130.

The interior surface of the pH protective optionally can have a contact angle (with distilled water) of from 90° to 110°, optionally from 80° to 120°, optionally from 70° to 130°, as measured by Goniometer Angle measurement of a water droplet on the pH protective surface, per ASTM D7334-08 “Standard Practice for Surface Wettability of Coatings, Substrates and Pigments by Advancing Contact Angie Measurement.”

The passivation layer or pH protective coating or layer 286 optionally shows an O-Parameter measured with attenuated total reflection (ATR) of less than 0.4, measured as:

$$O \text{-} Parameter = \frac{Intensity at 1253 cm \text{-} 1}{Maximum intensity in the range 1000 to 1100 cm \text{-} 1}$$

The O-Parameter is defined in U.S. Pat. No. 8,067,070, which claims an O-parameter value of most broadly from 0.4 to 0.9. It can be measured from physical analysis of an FTIR amplitude versus wave number plot to find the numerator and denominator of the above expression, as shown in FIG. 22, which is the same as FIG. 5 of U.S. Pat. No. 8,067,070, except annotated to show interpolation of the wave number and absorbance scales to arrive at an absorbance at 1253 cm-1 of 0.0424 and a maximum absorbance at 1000 to 1100 cm-1 of 0.08, resulting in a calculated O-parameter of 0.53. The O-Parameter can also be measured from digital wave number versus absorbance data.

U.S. Pat. No. 8,067,070 asserts that the claimed O-parameter range provides a superior pH protective coating or layer, relying on experiments only with HMDSO and HMDSN, which are both non-cyclic siloxanes. Surprisingly, it has been found by the present inventors that if the PECVD precursor is a cyclic siloxane, for example OMCTS, O-parameters outside the ranges claimed in U.S. Pat. No. 8,067,070, using OMCTS, provide even better results than are obtained in U.S. Pat. No. 8,067,070 with HMDSO.

Alternatively in the embodiment of FIGS. 19-21, the O-parameter has a value of from 0.1 to 0.39, or from 0.15 to 0.37, or from 0.17 to 0.35.

Even another aspect of the invention is a composite material as just described, exemplified in FIGS. 19-21, wherein the passivation layer shows an N-Parameter measured with attenuated total reflection (ATR) of less than 0.7, measured as:

$$N \text{-} Parameter = \frac{Intensity at 840 cm \text{-} 1}{Intensity at 799 cm \text{-} 1} .$$

The N-Parameter is also described in U.S. Pat. No. 8,067,070, and is measured analogously to the O-Parameter except that intensities at two specific wave numbers are used—neither of these wave numbers is a range. U.S. Pat. No. 8,067,070 claims a passivation layer with an N-Parameter of 0.7 to 1.6. Again, the present inventors have made better coatings employing a pH protective coating or layer 286 having an N-Parameter lower than 0.7, as described above. Alternatively, the N-parameter has a value of at least 0.3, or from 0.4 to 0.6, or at least 0.53.

The rate of erosion, dissolution, or leaching (different names for related concepts) of the pH protective coating or layer 286, if directly contacted by the fluid 218, is less than the rate of erosion of the barrier coating or layer 288, if directly contacted by the fluid 218.

The thickness of the pH protective coating or layer is contemplated to be from 50-500 nm, with a preferred range of 100-200 nm.

The pH protective coating or layer 286 is effective to isolate the fluid 218 from the barrier coating or layer 288, at least for sufficient time to allow the barrier coating to act as a barrier during the shelf life of the pharmaceutical package or other vessel 210.

The inventors have further found that certain pH protective coatings or layers of SiOₓC_{y} or SiNₓC_{y} formed from cyclic polysiloxane precursors, which pH protective coatings or layers have a substantial organic component, do not erode quickly when exposed to fluids, and in fact erode or dissolve more slowly when the fluids have higher pHs within the range of 5 to 9. For example, at pH 8, the dissolution rate of a pH protective coating or layer made from the precursor octamethylcyclotetrasiloxane, or OMCTS, is quite slow. These pH protective coatings or layers of SiOₓC_{y} or SiNₓC_{y} can therefore be used to cover a barrier layer of SiOₓ, retaining the benefits of the barrier layer by protecting it from the fluid in the pharmaceutical package. The protective layer is applied over at least a portion of the SiOₓ layer to protect the SiOₓ layer from contents stored in a vessel, where the contents otherwise would be in contact with the SiOₓ layer.

Although the present invention does not depend upon the accuracy of the following theory, it is further believed that effective pH protective coatings or layers for avoiding erosion can be made from cyclic siloxanes and silazanes as described in this disclosure. SiOₓC_{y} or SiNₓC_{y} coatings deposited from cyclic siloxane or linear silazane precursors, for example octamethylcyclotetrasiloxane (OMCTS), are believed to include intact cyclic siloxane rings and longer series of repeating units of the precursor structure. These coatings are believed to be nanoporous but structured and hydrophobic, and these properties are believed to contribute to their success as pH protective coatings or layers, and also protective coatings or layers. This is shown, for example, in U.S. Pat. No. 7,901,783.

SiOₓC_{y} or SiNₓC_{y} coatings also can be deposited from linear siloxane or linear silazane precursors, for example hexamethyldisiloxane (HMDSO) or tetramethyldisiloxane (TMDSO).

Optionally an FTIR absorbance spectrum of the pH protective coating or layer 286 of any embodiment has a ratio greater than 0.75 between the maximum amplitude of the Si—O—Si symmetrical stretch peak normally located between about 1000 and 1040 cm-1, and the maximum amplitude of the Si—O—Si assymmetric stretch peak normally located between about 1060 and about 1100 cm-1. Alternatively in any embodiment, this ratio can be at least 0.8, or at least 0.9, or at least 1.0, or at least 1.1, or at least 1.2. Alternatively in any embodiment, this ratio can be at most 1.7, or at most 1.6, or at most 1.5, or at most 1.4, or at most 1.3. Any minimum ratio stated here can be combined with any maximum ratio stated here, as an alternative embodiment of the invention of FIGS. 19-21.

Optionally, in any embodiment the pH protective coating or layer 286, in the absence of the medicament, has a non-oily appearance. This appearance has been observed in some instances to distinguish an effective pH protective coating or layer from a lubricity layer, which in some instances has been observed to have an oily (i.e. shiny) appearance.

Optionally, for the pH protective coating or layer 286 in any embodiment, the silicon dissolution rate by a 50 mM potassium phosphate buffer diluted in water for injection, adjusted to pH 8 with concentrated nitric acid, and containing 0.2 wt. % polysorbate-80 surfactant, (measured in the absence of the medicament, to avoid changing the dissolution reagent), at 40° C., is less than 170 ppb/day. (Polysorbate-80 is a common ingredient of pharmaceutical preparations, available for example as Tween®-80 from Uniqema Americas LLC, Wilmington Del.)

Optionally, for the pH protective coating or layer 286 in any embodiment, the silicon dissolution rate is less than 160 ppb/day, or less than 140 ppb/day, or less than 120 ppb/day, or less than 100 ppb/day, or less than 90 ppb/day, or less than 80 ppb/day. Optionally, in any embodiment of FIGS. 24-26 the silicon dissolution rate is more than 10 ppb/day, or more than 20 ppb/day, or more than 30 ppb/day, or more than 40 ppb/day, or more than 50 ppb/day, or more than 60 ppb/day. Any minimum rate stated here can be combined with any maximum rate stated here for the pH protective coating or layer 286 in any embodiment.

Optionally, for the pH protective coating or layer 286 in any embodiment the total silicon content of the pH protective coating or layer and barrier coating, upon dissolution into a test composition with a pH of 8 from the vessel, is less than 66 ppm, or less than 60 ppm, or less than 50 ppm, or less than 40 ppm, or less than 30 ppm, or less than 20 ppm.

### Graded Composite Layer

Another expedient contemplated here, for adjacent layers of SiOₓ and a pH protective coating or layer, is a graded composite of any two or more adjacent PECVD layers, for example the barrier coating or layer 288 and a pH protective coating or layer 286. A graded composite can be separate layers of a protective and/or barrier layer or coating with a transition or interface of intermediate composition between them, or separate layers of a protective and/or hydrophobic layer and SiOₓ with an intermediate distinct pH protective coating or layer of intermediate composition between them, or a single coating or layer that changes continuously or in steps from a composition of a protective and/or hydrophobic layer to a composition more like SiOₓ, going through the pH protective coating or layer in a normal direction.

The grade in the graded composite can go in either direction. For example, the composition of SiOₓ can be applied directly to the substrate and graduate to a composition further from the surface of a pH protective coating or layer, and optionally can further graduate to another type of coating or layer, such as a hydrophobic coating or layer or a lubricity coating or layer. Additionally, in any embodiment an adhesion coating or layer, for example Si_{w}OₓC_{y}, or its equivalent SiOₓC_{y}, optionally can be applied directly to the substrate before applying the barrier layer. A graduated pH protective coating or layer is particularly contemplated if a layer of one composition is better for adhering to the substrate than another, in which case the better-adhering composition can, for example, be applied directly to the substrate. It is contemplated that the more distant portions of the graded pH protective coating or layer can be less compatible with the substrate than the adjacent portions of the graded pH protective coating or layer, since at any point the pH protective coating or layer is changing gradually in properties, so adjacent portions at nearly the same depth of the pH protective coating or layer have nearly identical composition, and more widely physically separated portions at substantially different depths can have more diverse properties. It is also contemplated that a pH protective coating or layer portion that forms a better barrier against transfer of material to or from the substrate can be directly against the substrate, to prevent the more remote pH protective coating or layer portion that forms a poorer barrier from being contaminated with the material intended to be barred or impeded by the barrier.

The applied coatings or layers, instead of being graded, optionally can have sharp transitions between one layer and the next, without a substantial gradient of composition. Such pH protective coating or layer can be made, for example, by providing the gases to produce a layer as a steady state flow in a non-plasma state, then energizing the system with a brief plasma discharge to form a coating or layer on the substrate. If a subsequent pH protective coating or layer is to be applied, the gases for the previous pH protective coating or layer are cleared out and the gases for the next pH protective coating or layer are applied in a steady-state fashion before energizing the plasma and again forming a distinct layer on the surface of the substrate or its outermost previous pH protective coating or layer, with little if any gradual transition at the interface.

### pH Protective Coating or Layer Properties of any Embodiment

### Theory of Operation

The inventors offer the following theory of operation of the pH protective coating or layer described here. The invention is not limited by the accuracy of this theory or to the embodiments predictable by use of this theory.

The dissolution rate of the SiOₓ barrier layer is believed to be dependent on SiO bonding within the layer. Oxygen bonding sites (silanols) are believed to increase the dissolution rate.

It is believed that the OMCTS-based pH protective coating or layer bonds with the silanol sites on the SiOₓ barrier layer to “heal” or passivate the SiOₓ surface and thus dramatically reduces the dissolution rate. In this hypothesis, the thickness of the OMCTS layer is not the primary means of protection—the primary means is passivation of the SiOₓ surface. It is contemplated that a pH protective coating or layer as described in this specification can be improved by increasing the crosslink density of the pH protective coating or layer.

### Hydrophobic Layer

The protective or lubricity coating or layer of Si_{w}OₓC_{y} or its equivalent SiOₓC_{y} also can have utility as a hydrophobic layer, independent of whether it also functions as a pH protective coating or layer Suitable hydrophobic coatings or layers and their application, properties, and use are described in U.S. Pat. No. 7,985,188. Dual functional protective/hydrophobic coatings or layers having the properties of both types of coatings or layers can be provided for any embodiment of the present invention.

An embodiment can be carried out under conditions effective to form a hydrophobic pH protective coating or layer on the substrate. Optionally, the hydrophobic characteristics of the pH protective coating or layer can be set by setting the ratio of the O2 to the organosilicon precursor in the gaseous reactant, and/or by setting the electric power used for generating the plasma. Optionally, the pH protective coating or layer can have a lower wetting tension than the uncoated surface, optionally a wetting tension of from 20 to 72 dyne/cm, optionally from 30 to 60 dynes/cm, optionally from 30 to 40 dynes/cm, optionally 34 dyne/cm. Optionally, the pH protective coating or layer can be more hydrophobic than the uncoated surface.

Use of a coating or layer according to any described embodiment is contemplated as (i) a lubricity coating having a lower frictional resistance than the uncoated surface; and/or (ii) a pH protective coating or layer preventing dissolution of the barrier coating in contact with a fluid, and/or (iii) a hydrophobic layer that is more hydrophobic than the uncoated surface.

Optionally in any embodiment of the disclosure, the RMS surface roughness value of the pH protective coating or layer, measured by atomic force microscopy, is from about 5 to about 9, optionally from about 6 to about 8, optionally from about 6.4 to about 7.8.

Optionally in any embodiment of the disclosure, the Ra surface roughness value of the pH protective coating or layer, measured by atomic force microscopy, is from about 4 to about 6, optionally from about 4.6 to about 5.8.

Optionally in any embodiment of the disclosure, the Rmax surface roughness value of the pH protective coating or layer, measured by atomic force microscopy, is from about 70 to about 160, optionally from about 84 to about 142, optionally from about 90 to about 130.

The passivation layer or pH protective coating or layer 286 optionally shows an O-Parameter measured with attenuated total reflection (ATR) of less than 0.4, measured as:

$$O \text{-} Parameter = \frac{Intensity at 1253 cm \text{-} 1}{Maximum intensity in the range 1000 to 1100 cm \text{-} 1}$$

The O-Parameter is defined in U.S. Pat. No. 8,067,070, which claims an O-parameter value of most broadly from 0.4 to 0.9. It can be measured from physical analysis of an FTIR amplitude versus wave number plot to find the numerator and denominator of the above expression, as shown in FIG. 22, which is the same as FIG. 5 of U.S. Pat. No. 8,067,070, except annotated to show interpolation of the wave number and absorbance scales to arrive at an absorbance at 1253 cm-1 of 0.0424 and a maximum absorbance at 1000 to 1100 cm-1 of 0.08, resulting in a calculated O-parameter of 0.53. The O-Parameter can also be measured from digital wave number versus absorbance data.

U.S. Pat. No. 8,067,070 asserts that the claimed O-parameter range provides a superior pH protective coating or layer, relying on experiments only with HMDSO and HMDSN, which are both non-cyclic siloxanes. Surprisingly, it has been found by the present inventors that if the PECVD precursor is a cyclic siloxane, for example OMCTS, O-parameters outside the ranges claimed in U.S. Pat. No. 8,067,070, using OMCTS, provide even better results than are obtained in U.S. Pat. No. 8,067,070 with HMDSO.

Alternatively in the embodiment of FIGS. 19-21, the O-parameter has a value of from 0.1 to 0.39, or from 0.15 to 0.37, or from 0.17 to 0.35.

Even another aspect of the invention is a composite material as just described, exemplified in FIGS. 19-21, wherein the passivation layer shows an N-Parameter measured with attenuated total reflection (ATR) of less than 0.7, measured as:

$$N \text{-} Parameter = \frac{Intensity at 840 cm \text{-} 1}{Intensity at 799 cm \text{-} 1} .$$

The N-Parameter is also described in U.S. Pat. No. 8,067,070, and is measured analogously to the O-Parameter except that intensities at two specific wave numbers are used—neither of these wave numbers is a range. U.S. Pat. No. 8,067,070 claims a passivation layer with an N-Parameter of 0.7 to 1.6. Again, the present inventors have made better coatings employing a pH protective coating or layer 286 having an N-Parameter lower than 0.7, as described above. Alternatively, the N-parameter has a value of at least 0.3, or from 0.4 to 0.6, or at least 0.53.

### Tie Coating or Layer

Optionally in any embodiment of the disclosure, the coating (18) further comprises a tie coating or layer comprising SiOₓC_{y} or SiNₓC_{y}, wherein x is from about 0.5 to about 2.4 and y is from about 0.6 to about 3, between the barrier coating or layer and the interior surface.

Optionally in any embodiment of the disclosure, the tie coating or layer comprises or consists essentially of SiNₓC_{y}.

Optionally in any embodiment of the disclosure, the tie coating or layer comprises or consists essentially of SiNₓC_{y}.

Optionally in any embodiment of the disclosure, the tie coating or layer is applied by PECVD of a precursor feed comprising an acyclic siloxane, a monocyclic siloxane, a polycyclic siloxane, a polysilsesquioxane, a monocyclic silazane, a polycyclic silazane, a polysilsesquiazane, a silatrane, a silquasilatrane, a silproatrane, an azasilatrane, an azasilquasiatrane, an azasilproatrane, or a combination of any two or more of these precursors.

Optionally in any embodiment of the disclosure, the tie coating or layer is applied by PECVD of a precursor feed comprising an acyclic siloxane, a monocyclic siloxane, a polycyclic siloxane, a polysilsesquioxane, a silatrane, a silquasilatrane, a silproatrane, an acyclic silazane, a monocyclic silazane, a polycyclic silazane, a polysilsesquiazane, an azasilatrane, an azasilquasiatrane, an azasilproatrane, or a combination of any two or more of these precursors. or a combination of any two or more of these precursors.

Optionally in any embodiment of the disclosure, the tie coating or layer is applied by PECVD of a precursor feed comprising or consisting essentially of a monocyclic siloxane, for example octamethylcyclotetrasiloxane (OMCTS).

Optionally in any embodiment of the disclosure, the tie coating or layer is applied by PECVD of a precursor feed comprising or consisting essentially of an acyclic siloxane, for example tetramethyldisiloxane (TMDSO) or hexamethyldisiloxane (HMDSO).

Optionally in any embodiment of the disclosure, the precursor feed for the tie coating or layer further comprises oxygen.

Optionally in any embodiment of the disclosure, the precursor feed for the tie coating or layer further comprises a carrier gas, also known as a diluent gas. Optionally, the carrier gas for the tie coating or layer comprises argon.

Optionally in any embodiment of the disclosure, the precursor feed for the tie coating or layer comprises:
from 0.5 to 10 standard volumes of the organosilicon precursor;
from 0.1 to 10 standard volumes of oxygen; and
from 1 to 120 sccm of a carrier gas.

Optionally in any embodiment of the disclosure,
the organosilicon precursor for the tie coating or layer comprises TMDSO; and
the carrier gas for the tie coating or layer comprises Argon.

Optionally in any embodiment of the disclosure,
the organosilicon precursor for the tie coating or layer comprises HMDSO; and
the carrier gas for the tie coating or layer comprises Argon.

Optionally in any embodiment of the disclosure, the tie coating or layer is on average between 5 and 200 nm thick, or between 5 and 100 nm thick, or between 10 and 100 nm thick, or between 10 and 50 nm thick.

Optionally in any embodiment of the disclosure, the tie coating or layer is at least coextensive with the barrier coating or layer.

### Combination of Tie Layer, Barrier Layer, and pH Protective Layer

Optionally in any embodiment of the disclosure, the pH protective coating or layer and tie coating or layer together are effective to keep the barrier coating or layer at least substantially undissolved as a result of attack by the fluid composition for a period of at least six months.

### PECVD Method

Another aspect of the present disclosure is a method of applying a barrier coating of SiOₓ, in which x is from about 1.5 to about 2.9, on a chromatography vial as identified above. The method can be carried out generally as follows.

A chromatography vial 10 is provided, as described above. A reaction mixture is provided that includes a precursor gas, for example an organosilicon compound gas. The reaction mixture optionally includes an oxidizing gas, optionally includes a carrier or diluent gas, and optionally includes a hydrocarbon gas. A plasma is formed in the reaction mixture by energizing the vicinity of the precursor with electrodes such as 108 and 160 supplied with electric power at equal to or more than 5 W/ml. of plasma volume. The interior surface of the chromatography vial 10 is contacted with the reaction mixture, and a coating 18 of SiOₓ, optionally further including other coatings, is deposited on at least a portion of the interior surface 16 of the chromatography vial 10.

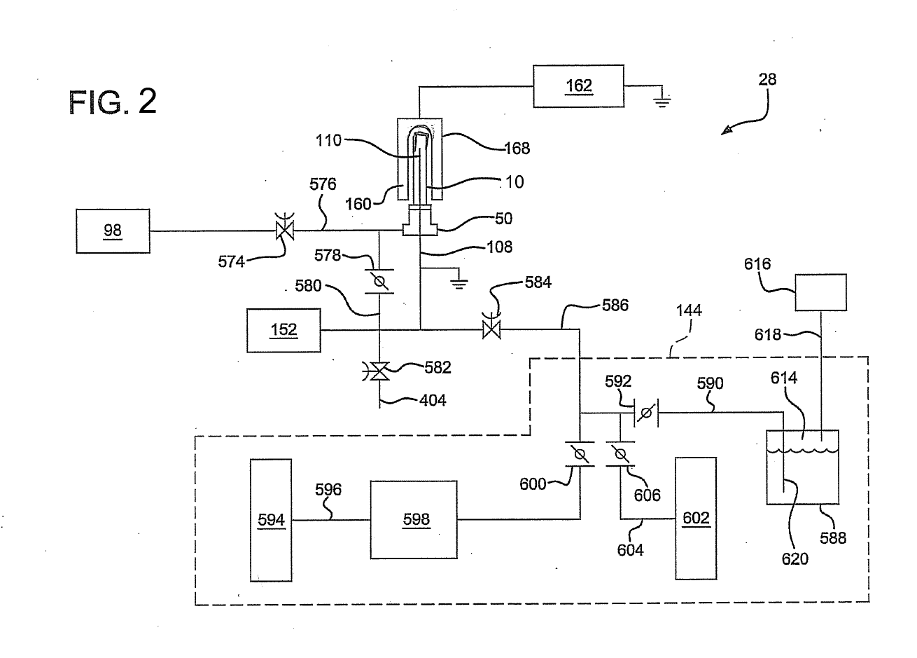

The present methods can be carried out, for example, in apparatus such as that shown generally in FIG. 2. The plasma enhanced chemical vapor deposition (PECVD) apparatus of FIG. 2 shows a coating station 28 including a vessel holder 50, an inner electrode defined by the probe or counter electrode 108, an outer electrode 160 (in this embodiment having a closed end 168, which is optional), and a power supply 162.

A vessel such as the chromatography vial 10 seated on the vessel holder 50 defines a plasma reaction chamber, which optionally can be a vacuum chamber. Optionally, a vacuum source 98, a PECVD gas source 144, a gas feed such as the gas delivery port 110, or a combination of two or more of these can be supplied. Optionally, a gas drain such as the vent 404 can be provided, fed by a bypass valve 578, a bypass line such as 580, and a vent valve 582. A pressure gauge 152 can be provided for indicating the pressure in the lumen 20. In this embodiment, a vacuum optionally is drawn in the chromatography vial 10 or other container by a vacuum source 98 drawing vacuum through a vacuum line 576 controlled by a main vacuum valve 574 to transfer gas from the interior of a vessel 10 seated on the vessel holder 50.

The PECVD apparatus can be used for atmospheric-pressure PECVD, in which case the plasma reaction chamber does not need to function as a vacuum chamber and the vacuum source is not required.

The probe 108 can be a gas inlet conduit that extends to a gas delivery port at its distal end 110. The distal end 110 of the illustrated embodiment can be inserted deep into the vessel 80 for providing one or more PECVD reactants and other gaseous reactant or process gases.

Flow out of the PECVD gas or precursor source 144 is controlled by a main reactant gas valve 584 regulating flow through the main reactant feed line 586.

One component of the PECVD gas or precursor source 144 is the organosilicon liquid reservoir 588. The contents of the reservoir 588 are drawn through the organosilicon capillary line 590, which is provided at a suitable length to provide the desired flow rate. Flow of organosilicon vapor is controlled by the organosilicon shut-off valve 592. Pressure is applied to the headspace 614 of the liquid reservoir 588, for example a pressure in the range of 0-15 psi (0 to 78 cm. Hg), from a pressure source 616 such as pressurized air connected to the headspace 614 by a pressure line 618 to establish repeatable organosilicon liquid delivery that is not dependent on atmospheric pressure (and the fluctuations therein). The reservoir 588 is sealed and the capillary connection 620 is at the bottom of the reservoir 588 to ensure that only neat organosilicon liquid (not the pressurized gas from the headspace 614) flows through the capillary tube 590. The organosilicon liquid optionally can be heated above ambient temperature, if necessary or desirable to cause the organosilicon liquid to evaporate, forming an organosilicon vapor.

An optional component of the PECVD gas or precursor source 144 is an oxygen source. Oxygen is provided from the oxygen tank 594 via an oxygen feed line 596 controlled by a mass flow controller 598 and provided with an oxygen shut-off valve 600.

Another optional component of the PECVD gas or precursor source 144 is a diluent or carrier gas source. A diluent or carrier gas, here best characterized as a diluent gas, is supplied from the diluent or carrier gas 602 via a conduit 604 and a shut-off valve 606 to the main reactant feed line 586.

The processing station 28 can include an electrode 160 fed by a radio frequency power supply 162 for providing an electric field for generating plasma within the vessel 80 during processing. In this embodiment, the probe 108 is also electrically conductive and is grounded, thus providing a counter-electrode within the vessel 80. Alternatively, in any embodiment the outer electrode 160 can be grounded and the probe 108 directly connected to the power supply 162.

In the embodiment of FIG. 2, the outer electrode 160 can be generally cylindricalor any other suitable shape. The electrode 160 shown in FIG. 2 alternatively can be shaped like a “U” channel with its length into the page and the puck or vessel holder 50 can move through the activated (powered) electrode during the treatment/coating process. Note that since external and internal electrodes are used, this apparatus can employ a frequency between 50 Hz and 1 GHz applied from a power supply 162 to the U channel electrode 160. The probe 108 can be grounded to complete the electrical circuit, allowing current to flow through the low-pressure gas(es) inside of the vessel 80. The current creates plasma to allow the selective treatment and/or coating of the interior surface 88 of the device.

The electrode in FIG. 2 can also be powered by a pulsed power supply. Pulsing allows for depletion of reactive gases and then removal of by-products prior to activation and depletion (again) of the reactive gases. Pulsed power systems are typically characterized by their duty cycle which determines the amount of time that the electric field (and therefore the plasma) is present. The power-on time is relative to the power-off time. For example a duty cycle of 10% can correspond to a power on time of 10% of a cycle and a power off time of 90% of a cycle. As a specific example, the power might be on for 0.1 second and off for 1 second. Pulsed power systems reduce the effective power input for a given power supply 162, since the off-time results in increased processing time. When the system is pulsed, the resulting coating can be very pure (no by products or contaminants). Another result of pulsed systems is the possibility to achieve atomic layer or coating deposition (ALD). In this case, the duty cycle can be adjusted so that the power-on time results in the deposition of a single layer or coating of a desired material. In this manner, a single atomic layer or coating is contemplated to be deposited in each cycle. This approach can result in highly pure and highly structured coatings (although at the temperatures required for deposition on polymeric surfaces, temperatures optionally are kept low (<100° C.) and the low-temperature coatings can be amorphous).

An alternative coating station employs a microwave cavity instead of an outer electrode. The energy applied can be a microwave frequency, for example 2.45 GHz. However, in the context of present invention, a radio frequency is preferred.

Measurement of Coating Thickness

The thickness of a PECVD coating or layer such as the passivation layer or pH protective coating, the barrier coating or layer, the lubricity coating or layer, and/or a composite of any two or more of these layers can be measured, for example, by transmission electron microscopy (TEM). An exemplary TEM image for a lubricity and/or passivation layer or pH protective coating on an SiOₓ barrier coating or layer is shown in FIG. 12. An exemplary TEM image for an SiOₓ barrier coating or layer on a substrate is shown in FIG. 13.

The TEM can be carried out, for example, as follows. Samples can be prepared for Focused Ion Beam (FIB) cross-sectioning in two ways. Either the samples can be first coated with a thin layer of carbon (50-100 nm thick) and then coated with a sputtered coating or layer of platinum (50-100 nm thick) using a K575X Emitech passivation layer or pH protective coating system, or the samples can be coated directly with the protective sputtered Pt layer. The coated samples can be placed in an FEI FIB200 FIB system. An additional coating or layer of platinum can be FIB-deposited by injection of an organometallic gas while rastering the 30 kV gallium ion beam over the area of interest. The area of interest for each sample can be chosen to be a location half way down the length of the syringe barrel. Thin cross sections measuring approximately 15 μm (“micrometers”) long, 2 μm wide and 15 μm deep can be extracted from the die surface using an in-situ FIB lift-out technique. The cross sections can be attached to a 200 mesh copper TEM grid using FIB-deposited platinum. One or two windows in each section, measuring about 8 μm wide, can be thinned to electron transparency using the gallium ion beam of the FEI FIB.

Cross-sectional image analysis of the prepared samples can be performed utilizing either a Transmission Electron Microscope (TEM), or a Scanning Transmission Electron Microscope (STEM), or both. All imaging data can be recorded digitally. For STEM imaging, the grid with the thinned foils can be transferred to a Hitachi HD2300 dedicated STEM. Scanning transmitted electron images can be acquired at appropriate magnifications in atomic number contrast mode (ZC) and transmitted electron mode (TE). The following instrument settings can be used.

| | |
|---|---|
| Instrument | Scanning Transmission Electron |
| | Microscope |
| Manufacturer/Model | Hitachi HD2300 |
| Accelerating Voltage | 200 kV |
| Objective Aperture | #2 |
| Condenser Lens 1 Setting | 1.672 |
| Condenser Lens 2 Setting | 1.747 |
| Approximate Objective Lens Setting | 5.86 |
| ZC Mode Projector Lens | 1.149 |
| TE Mode Projector Lens | 0.7 |
| Image Acquisition | |
| Pixel Resolution | 1280 × 960 |
| Acquisition Time | 20 sec.(×4 |

For TEM analysis the sample grids can be transferred to a Hitachi HF2000 transmission electron microscope. Transmitted electron images can be acquired at appropriate magnifications. The relevant instrument settings used during image acquisition can be those given below.

| | |
|---|---|
| Instrument | Transmission Electron Microscope |
| Manufacturer/Model | Hitachi HF2000 |
| Accelerating Voltage | 200 kV |
| Condenser Lens 1 | 0.78 |
| Condenser Lens 2 | 0 |
| Objective Lens | 6.34 |
| Condenser Lens Aperture | #1 |
| Objective Lens Aperture for imaging | #3 |
| Selective Area Aperture for SAD | N/A |

### Basic Protocols for Forming and Coating Syringe Barrels

The pharmaceutical packages or other vessels tested in the subsequent working examples were formed and coated according to the following exemplary protocols, except as otherwise indicated in individual examples. Particular parameter values given in the following basic protocols, for example the electric power and gaseous reactant or process gas flow, are typical values. When parameter values were changed in comparison to these typical values, this will be indicated in the subsequent working examples. The same applies to the type and composition of the gaseous reactant or process gas.

In some instances, the reference characters and Figures mentioned in the following protocols and additional details can be found in U.S. Pat. No. 7,985,188.

Protocol for Coating Syringe Barrel Interior with SiOₓ

The apparatus and protocol generally as found in U.S. Pat. No. 7,985,188 were used for coating thermoplastic syringe barrel interiors with an SiOₓ barrier coating or layer, in some cases with minor variations. A similar apparatus and protocol were used for coating vials with an SiOₓ barrier coating or layer, in some cases with minor variations. The syringe testing is related below to results expected for thermoplastic chromatography vials.

Protocol for Coating Syringe Barrel Interior with OMCTS Passivation Layer or pH Protective Coating

Syringe barrels already interior coated with a barrier coating or layer of SiOₓ, as previously identified, are further interior coated with a passivation layer or pH protective coating as previously identified, generally following the protocols of U.S. Pat. No. 7,985,188 for applying the lubricity coating or layer, except with modified conditions in certain instances as noted in the working examples. The conditions given here are for a COC syringe barrel, and can be modified as appropriate for syringe barrels made of other materials. The apparatus as generally shown in FIG. 4 can be used to hold a syringe barrel with butt sealing at the base of the syringe barrel.

The syringe barrel is carefully moved into the sealing position over the extended probe or counter electrode 108 and pushed against a plasma screen. The plasma screen is fit snugly around the probe or counter electrode 108 insuring good electrical contact. The probe or counter electrode 108 is grounded to the casing of the RF matching network.

The gas delivery port 110 is connected to a manual ball valve or similar apparatus for venting, a thermocouple pressure gauge and a bypass valve connected to the vacuum pumping line. In addition, the gas system is connected to the gas delivery port 110 allowing the gaseous reactant or process gas, octamethylcyclotetrasiloxane (OMCTS) (or the specific gaseous reactant or process gas reported for a particular example) to be flowed through the gas delivery port 110 (under process pressures) into the interior of the syringe barrel.

The gas system is comprised of a commercially available heated mass flow vaporization system that heats the OMCTS to about 100° C. The heated mass flow vaporization system is connected to liquid octamethylcyclotetrasiloxane (Alfa Aesar®Part Number A12540, 98%). The OMCTS flow rate is set to the specific organosilicon precursor flow reported for a particular example. To ensure no condensation of the vaporized OMCTS flow past this point, the gas stream is diverted to the pumping line when it is not flowing into the interior of the COC syringe barrel for processing.

Once the syringe barrel is installed, the vacuum pump valve is opened to the vessel holder 50 and the interior of the COC syringe barrel. A vacuum pump and blower comprise the vacuum pump system. The pumping system allows the interior of the COC syringe barrel to be reduced to pressure(s) of less than 100 mTorr while the gaseous reactant or process gases is flowing at the indicated rates.

Once the base vacuum level is achieved, the vessel holder 50 assembly is moved into the electrode 160 assembly. The gas stream (OMCTS vapor) is flowed into the gas delivery port 110 (by adjusting the 3-way valve from the pumping line to the gas delivery port 110. The plasma for PECVD, if used, can be generated at reduced pressure and the reduced pressure can be less than 300 mTorr, optionally less than 200 mTorr, even optionally less than 100 mTorr. Pressure inside the COC syringe barrel can be, as one example, approximately 140 mTorr as measured by a capacitance manometer (MKS) installed on the pumping line near the valve that controls the vacuum. In addition to the COC syringe barrel pressure, the pressure inside the gas delivery port 110 and gas system is also measured with the thermocouple vacuum gauge that is connected to the gas system. This pressure is typically less than 6 Torr.

Once the gas is flowing to the interior of the COC syringe barrel, the RF power supply is turned on to its fixed power level or as otherwise indicated in a specific example or description. The physical and chemical properties of the passivation layer or pH protective coating can be set by setting the ratio of oxidizing gas to the organosilicon precursor in the gaseous reactant, and/or by setting the electric power used for generating the plasma. A 600 Watt RF power supply is used (at 13.56 MHz) at a fixed power level or as otherwise indicated in a specific example or description. The RF power supply is connected to an auto match which matches the complex impedance of the plasma (to be created in the vessel) to the output impedance of the RF power supply. The forward power is as stated and the reflected power is 0 Watts so that the stated power is delivered to the interior of the vessel. The RF power supply is controlled by a laboratory timer and the power on time set to 10 seconds (or a different time stated in a given example).

Upon initiation of the RF power, uniform plasma is established inside the interior of the vessel. The plasma is maintained for the entire passivation layer or pH protective coating time, until the RF power is terminated by the timer. The plasma produces a passivation layer or pH protective coating on the interior of the vessel.

After applying the passivation layer or pH protective coating, the gas flow is diverted back to the vacuum line and the vacuum valve is closed. The vent valve is then opened, returning the interior of the COC syringe barrel to atmospheric pressure (approximately 760 Torr). The treated vessel is then carefully removed from the vessel holder 50 assembly (after moving the vessel holder 50 assembly out of the electrode 160 assembly).

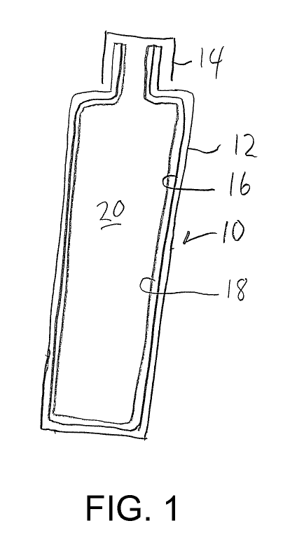

A similar protocol is used, except using apparatus generally like that of FIG. 1, for applying a passivation layer or pH protective coating to vials.

### Protocol for Total Silicon Measurement

This protocol is used to determine the total amount of silicon coatings present on the entire vessel wall. A supply of 0.1 N potassium hydroxide (KOH) aqueous solution is prepared, taking care to avoid contact between the solution or ingredients and glass. The water used is purified water, 18 m′Ω quality. A Perkin Elmer Optima Model 7300DV ICP-OES instrument is used for the measurement except as otherwise indicated.

Each device (vial, syringe, tube, or the like) to be tested and its cap and crimp (in the case of a vial) or other closure are weighed empty to 0.001 g, then filled completely with the KOH solution (with no headspace), capped, crimped, and reweighed to 0.001 g. In a digestion step, each vial is placed in a sonicating water bath at 40° C. for a minimum of 8-10 hours. The digestion step is carried out to quantitatively remove the silicon coatings from the vessel wall into the KOH solution. After this digestion step, the vials are removed from the sonicating water bath and allowed to cool to room temperature. The contents of the vials are transferred into 15 ml ICP tubes. The total Si concentration is run on each solution by ICP/OES following the operating procedure for the ICP/OES.

The total Si concentration is reported as parts per billion of Si in the KOH solution. This concentration represents the total amount of silicon coatings that were on the vessel wall before the digestion step was used to remove it.

The total Si concentration can also be determined for fewer than all the silicon layers on the vessel, as when an SiOₓ barrier coating or layer is applied, an SiOₓC_{y} second layer (for example, a lubricity layer or a passivation layer or pH protective coating) is then applied, and it is desired to know the total silicon concentration of just the SiOₓC_{y} layer. This determination is made by preparing two sets of vessels, one set to which only the SiOₓ layer is applied and the other set to which the same SiOₓ layer is applied, followed by the SiOₓC_{y} layer or other layers of interest. The total Si concentration for each set of vessels is determined in the same manner as described above. The difference between the two Si concentrations is the total Si concentration of the SiOₓC_{y} second layer.

### Protocol for Measuring Dissolved Silicon in a Vessel

In some of the working examples, the amount of silicon dissolved from the wall of the vessel by a test solution is determined, in parts per billion (ppb), for example to evaluate the dissolution rate of the test solution. This determination of dissolved silicon is made by storing the test solution in a vessel provided with an SiOₓ and/or SiOₓC_{y} coating or layer under test conditions, then removing a sample of the solution from the vessel and testing the Si concentration of the sample. The test is done in the same manner as the Protocol for Total Silicon Measurement, except that the digestion step of that protocol is replaced by storage of the test solution in the vessel as described in this protocol. The total Si concentration is reported as parts per billion of Si in the test solution

### Protocol for Determining Average Dissolution Rate

The average dissolution rates reported in the working examples are determined as follows. A series of test vessels having a known total total silicon measurement are filled with the desired test solution analogous to the manner of filling the vials with the KOH solution in the Protocol for Total Silicon Measurement. (The test solution can be a physiologically inactive test solution as employed in the present working examples or a physiologically active pharmaceutical preparation intended to be stored in the vessels to form a pharmaceutical package). The test solution is stored in respective vessels for several different amounts of time, then analyzed for the Si concentration in parts per billion in the test solution for each storage time. The respective storage times and Si concentrations are then plotted. The plots are studied to find a series of substantially linear points having the steepest slope.

The plot of dissolution amount (ppb Si) versus days decreases in slope with time. It is believed that the dissolution rate is not flattening out because the Si layer has been fully digested by the test solution.

For the PC194 test data in Table 10 below, linear plots of dissolution versus time data are prepared by using a least squares linear regression program to find a linear plot corresponding to the first five data points of each of the experimental plots. The slope of each linear plot is then determined and reported as representing the average dissolution rate applicable to the test, measured in parts per billion of Si dissolved in the test solution per unit of time.

### Protocol for Determining Calculated Shelf Life

The calculated shelf life values reported in the working examples below are determined by extrapolation of the total silicon measurements and average dissolution rates, respectively determined as described in the Protocol for Total Silicon Measurement and the Protocol for Determining Average Dissolution Rate. The assumption is made that under the indicated storage conditions the SiOₓC_{y} passivation layer or pH protective coating will be removed at the average dissolution rate until the coating is entirely removed. Thus, the total silicon measurement for the vessel, divided by the dissolution rate, gives the period of time required for the test solution to totally dissolve the SiOₓC_{y} coating. This period of time is reported as the calculated shelf life. Unlike commercial shelf life calculations, no safety factor is calculated. Instead, the calculated shelf life is the calculated time to failure.

It should be understood that because the plot of ppb Si versus hours decreases in slope with time, an extrapolation from relatively short measurement times to relatively long calculated shelf lives is believed to be a “worst case” test that tends to underestimate the calculated shelf life actually obtainable.

### SEM Procedure

SEM Sample Preparation: Each syringe sample was cut in half along its length (to expose the inner or interior surface). The top of the syringe (Luer end) was cut off to make the sample smaller.

The sample was mounted onto the sample holder with conductive graphite adhesive, then put into a Denton Desk IV SEM Sample Preparation System, and a thin (approximately 50 Å) gold passivation layer or pH protective coating was sputtered onto the inner or interior surface of the syringe. The gold passivation layer or pH protective coating is required to eliminate charging of the surface during measurement.

The sample was removed from the sputter system and mounted onto the sample stage of a Jeol JSM 6390 SEM (Scanning Electron Microscope). The sample was pumped down to at least 1×10⁻⁶ Torr in the sample compartment. Once the sample reached the required vacuum level, the slit valve was opened and the sample was moved into the analysis station.

The sample was imaged at a coarse resolution first, then higher magnification images were accumulated. The SEM images provided in the Figures are 5 μm edge-to-edge (horizontal and vertical).

### AFM (Atomic Force Microscopy) Procedure.

AFM images were collected using a NanoScope III Dimension 3000 machine (Digital Instruments, Santa Barbara, Calif., USA). The instrument was calibrated against a NIST traceable standard. Etched silicon scanning probe microscopy (SPM) tips were used. Image processing procedures involving auto-flattening, plane fitting or convolution were employed. One 10 μm×10 μm area was imaged. Roughness analyses were performed and were expressed in: (1) Root-Mean-Square Roughness, RMS; 2 Mean Roughness, Ra; and (3) Maximum Height (Peak-to-Valley), Rₘₐₓ, all measured in nm (see Table 5). For the roughness analyses, each sample was imaged over the 10 μm×10 μm area, followed by three cross sections selected by the analyst to cut through features in the 10 μm×10 μm images. The vertical depth of the features was measures using the cross section tool. For each cross section, a Root-Mean-Square Roughness (RMS) in nanmeters was reported. These RMS values along with the average of the three cross sections for each sample are listed in Table 5.

Additional analysis of the 10 μm×10 μm images represented by Examples Q, T and V was carried out. For this analysis three cross sections were extracted from each image. The locations of the cross sections were selected by the analyst to cut through features in the images. The vertical depth of the features was measured using the cross section tool.

The Digital Instruments Nanoscope III AFM/STM acquires and stores 3-dimensional representations of surfaces in a digital format. These surfaces can be analyzed in a variety of ways.

The Nanoscope III software can perform a roughness analysis of any AFM or STM image. The product of this analysis is a single page reproducing the selected image in top view. To the upper right of the image is the “Image Statistics” box, which lists the calculated characteristics of the whole image minus any areas excluded by a stopband (a box with an X through it). Similar additional statistics can be calculated for a selected portion of the image and these are listed in the “Box Statistics” in the lower right portion of the page. What follows is a description and explanation of these statistics.

Image Statistics:

Z Range (Rₚ): The difference between the highest and lowest points in the image. The value is not corrected for tilt in the plane of the image; therefore, plane fitting or flattening the data will change the value.

Mean: The average of all of the Z values in the imaged area. This value is not corrected for the tilt in the plane of the image; therefore, plane fitting or flattening the data will change this value.

RMS (R_{q}): This is the standard deviation of the Z values (or RMS roughness) in the image. It is calculated according to the formula:

R_{q}={Σ(Z₁−Z_{avg})2/N}

where Z_{avg} is the average Z value within the image; Z₁ is the current value of Z; and N is the number of points in the image. This value is not corrected for tilt in the plane of the image; therefore, plane fitting or flattening the data will change this value.

Mean roughness (Rₐ): This is the mean value of the surface relative to the Center Plane and is calculated using the formula:

Rₐ=[1/(LₓL_{y})]∫ₒ^{Ly}∫ₒ^{Lx}{f(x,y)}dxdy

where f(x,y) is the surface relative to the Center plane, and Lₓ and L_{y} are the dimensions of the surface.

Max height (Rₘₐₓ): This is the difference in height between the highest and lowest points of the surface relative to the Mean Plane.

Surface area: (Optical calculation): This is the area of the 3-dimensional surface of the imaged area. It is calculated by taking the sum of the areas of the triangles formed by 3 adjacent data points throughout the image.

Surface area diff: (Optional calculation) This is the amount that the Surface area is in excess of the imaged area. It is expressed as a percentage and is calculated according to the formula:

Surface area diff=100[(Surface area/S₁2−1]

where S₁ is the length (and width) of the scanned area minus any areas excluded by stopbands.

Center Plane: A flat plane that is parallel to the Mean Plane. The volumes enclosed by the image surface above and below the center plane are equal.

Mean Plane: The image data has a minimum variance about this flat plane. It results from a first order least squares fit on the Z data.

### EXAMPLES

The following working examples are adapted from working examples carried out on thermoplastic syringe barrels and thermoplastic general-purpose vials, as reported in WO2013/071138. It is anticipated that comparable results are obtainable from comparable testing carried out on thermoplastic chromatography vials.

### Examples A-D

Canceled.

### Examples E-H

Syringe samples E and F were produced as follows. A COC 8007 extended barrel syringe was produced according to the Protocol for Forming COC Syringe Barrel. An SiOₓ passivation layer or pH protective coating was applied to the syringe barrels according to the Protocol for Coating COC Syringe Barrel Interior with SiOₓ. A lubricity and/or passivation layer or pH protective coating was applied to the SiOₓ coated syringes according to the Protocol for Coating COC Syringe Barrel Interior with OMCTS, modified as follows. Argon carrier gas and oxygen were used where noted in Table 2. The process conditions were set to the following, or as indicated in Table 2:
OMCTS—3 sccm (when used)
Argon gas—7.8 sccm (when used)
Oxygen 0.38 sccm (when used)
Power—3 watts
Power on time—10 seconds

Syringes G were prepared under these conditions except without a pH protective coating.

Syringes E, F, and G were also tested to determine total extractable silicon levels (representing extraction of the organosilicon-based PECVD passivation layer or pH protective coating) using the Protocol for Measuring Dissolved Silicon in a Vessel, modified and supplemented as shown in this example.

The silicon was extracted using saline water digestion. The tip of each syringe plunger tip, piston, stopper, or seal was covered with PTFE tape to prevent extracting material from the elastomeric tip material, then inserted into the syringe barrel base. The syringe barrel was filled with two milliliters of 0.9% aqueous saline solution via a hypodermic needle inserted through the Luer tip of the syringe. This is an appropriate test for extractables because many prefilled syringes are used to contain and deliver saline solution. The Luer tip was plugged with a piece of PTFE beading of appropriate diameter. The syringe was set into a PTFE test stand with the Luer tip facing up and placed in an oven at 50° C. for 72 hours.

Then, either a static or a dynamic mode was used to remove the saline solution from the syringe barrel. According to the static mode indicated in Table 2, the syringe plunger tip, piston, stopper, or seal was removed from the test stand, and the fluid in the syringe was decanted into a vessel. According to the dynamic mode indicated in Table 2, the Luer tip seal was removed and the plunger tip, piston, stopper, or seal was depressed to push fluid through the syringe barrel and expel the contents into a vessel. In either case, the fluid obtained from each syringe barrel was brought to a volume of 50 ml using 18.2MΩ-cm deionized water and further diluted 2× to minimize sodium background during analysis. The CVH barrels contained two milliliters and the commercial barrels contained 2.32 milliliters.

Next, the fluid recovered from each syringe was tested for extractable silicon using the Protocol for Measuring Dissolved Silicon in a Vessel. The instrument used was a Perkin Elmer Elan DRC II equipped with a Cetac ASX-520 autosampler. The following ICP-MS conditions were employed:
Nebulizer: Quartz Meinhardt
Spray Chamber: Cyclonic
RF (radio frequency) power: 1550 Watts
Argon (Ar) Flow: 15.0 L/min
Auxiliary Ar Flow: 1.2 L/min
Nebulizer Gas Flow: 0.88 L/min
Integration time: 80 sec
Scanning mode: Peak hopping
RPq (The RPq is a rejection parameter) for Cerium as CeO (m/z 156:<2%

Aliquots from aqueous dilutions obtained from Syringes E, F, and G were injected and analyzed for Si in concentration units of micrograms per liter. The results of this test are shown in Table 2. While the results are not quantitative, they do indicate that extractables from the lubricity and/or passivation layer or pH protective coating are not clearly higher than the extractables for the SiOₓ barrier coating or layer only. Also, the static mode produced far less extractables than the dynamic mode, which was expected.

### Examples I-K

Syringe samples I, J, and K, employing three different lubricity and/or passivation layers or pH protective coatings or layers, were produced in the same manner as for Examples E-H except as follows or as indicated in Table 3:
OMCTS—2.5 sccm
Argon gas—7.6 sccm (when used)
Oxygen 0.38 sccm (when used)
Power—3 watts
Power on time—10 seconds

Syringe I had a three-component pH protective coating employing OMCTS, oxygen, and carrier gas. Syringe J had a two component pH protective coating employing OMCTS and oxygen, but no carrier gas. Syringe K had a one-component passivation layer or pH protective coating (OMCTS only). The coatings produced according to these working examples are contemplated to function as pH protective coatings or layers to increase the shelf life of the vessels, compared to similar vessels provided with a barrier coating or layer but no pH protective coating or layer.

### Examples L-N

Examples I-K using an OMCTS precursor gas were repeated in Examples L-N, except that HMDSO was used as the precursor in Examples L-N. The resulting pH protective coatings or layers are contemplated to increase the shelf life of the vessels, compared to similar vessels provided with a barrier coating or layer but no pH protective coating or layer.

### Examples O-Y

In these examples the surface roughness of the pH protective coating was measured. OMCTS lubricity coatings or layers were applied with previously described equipment with the indicated specific process conditions (Table 5) onto one milliliter COC 6013 molded syringe barrels. Scanning electron spectroscopy (SEM) photomicrographs (Table 5) and atomic force microscopy (AFM) Root Mean Square (RMS) and other roughness determinations (Tables 5 and 6) were made using the procedures indicated below. Average RMS values are taken from three different RMS readings on the surface. The AFM and SEM tests reported in table 5 were performed on different samples due to the nature of the individual tests which prohibited a performance of all tests on one sample.

Further testing was carried out on sister samples Examples W, X, and Y, respectively made under conditions similar to Example Q, T, and V, to show the AFM roughness data.

The pH protective coatings or layers are contemplated to increase the shelf life of the vessels, compared to similar vessels provided with a barrier coating or layer but no pH protective coating or layer.

### Summary of Protective Measurements

Table 8 shows a summary of the above OMCTS pH protective coatings or layers.

### Example Z

### pH Protective Coating Extractables

Silicon extractables from syringes were measured using ICP-MS analysis as described in the Protocol for Measuring Dissolved Silicon in a Vessel. The syringes were evaluated in both static and dynamic situations. The Protocol for Measuring Dissolved Silicon in a Vessel, modified as follows, describes the test procedure:
Syringe filled with 2 ml of 0.9% saline solution
Syringe placed in a stand—stored at 50° C. for 72 hours.
After 72 hours saline solution test for dissolved silicon
Dissolved silicon measured before and after saline solution expelled through syringe.

The extractable Silicon Levels from a silicone oil coated glass syringe and a pH protective coated and SiOₓ coated COC syringe are shown in Table 7. Precision of the ICP-MS total silicon measurement is +/−3%.

### Comparative Example AA

### Dissolution of SiOₓ Coating Versus pH

The Protocol for Measuring Dissolved Silicon in a Vessel is followed, except as modified here. Test solutions—50 mM buffer solutions at pH 3, 6, 7, 8, 9, and 12 are prepared. Buffers are selected having appropriate pKa values to provide the pH values being studied. A potassium phosphate buffer is selected for pH 3, 7, 8 and 12, a sodium citrate buffer is utilized for pH 6 and tris buffer is selected for pH 9. 3 ml of each test solution is placed in borosilicate glass 5 ml pharmaceutical vials and SiOₓ coated 5 ml thermoplastic pharmaceutical vials. The vials are all closed with standard coated stoppers and crimped. The vials are placed in storage at 20-25° C. and pulled at various time points for inductively coupled plasma spectrometer (ICP) analysis of Si content in the solutions contained in the vials, in parts per billion (ppb) by weight, for different storage times.

The Protocol for Determining Average Dissolution Rate Si content is used to monitor the rate of silicon dissolution, except as modified here. The data is plotted to determine an average rate of dissolution of borosilicate glass or SiOₓ coating at each pH condition. Representative plots at pH 6 through 8 are FIGS. 14-16.

The rate of Si dissolution in ppb is converted to a predicted thickness (nm) rate of Si dissolution by determining the total weight of Si removed, then using a surface area calculation of the amount of vial surface (11.65 cm²) exposed to the solution and a density of SiOₓ of 2.2 g/cm³. FIG. 17 shows the predicted initial thickness of the SiOₓ coating required, based on the conditions and assumptions of this example (assuming a residual SiOₓ coating of at least 30 nm at the end of the desired shelf life of two years, and assuming storage at 20 to 25° C.). As FIG. 17 shows, the predicted initial thickness of the coating is about 36 nm at pH 5, about 80 nm at pH 6, about 230 nm at pH 7, about 400 nm at pH 7.5, about 750 nm at pH 8, and about 2600 nm at pH 9.

The coating thicknesses in FIG. 17 represent atypically harsh case scenarios for pharma and biotech products. Most biotech products and many pharma products are stored at refrigerated conditions and none are typically recommended for storage above room temperature. As a general rule of thumb, storage at a lower temperature reduces the thickness required, all other conditions being equivalent.

The following conclusions are reached, based on this test. First, the amount of dissolved Si in the SiOₓ coating or glass increases exponentially with increasing pH. Second, the SiOₓ coating dissolves more slowly than borosilicate glass at a pH lower than 8. The SiOₓ coating shows a linear, monophasic dissolution over time, whereas borosilicate glass tends to show a more rapid dissolution in the early hours of exposure to solutions, followed by a slower linear dissolution. This may be due to surface accumulation of some salts and elements on borosilicate during the forming process relative to the uniform composition of the SiOₓ coating. This result incidentally suggests the utility of an SiOₓ coating on the wall of a borosilicate glass vial to reduce dissolution of the glass at a pH lower than 8. Third, PECVD applied barrier coatings or layers for vials in which pharmaceutical preparations are stored will need to be adapted to the specific pharmaceutical preparation and proposed storage conditions (or vice versa), at least in some instances in which the pharmaceutical preparation interacts with the barrier coating or layer significantly.

### Example BB

An experiment is conducted with vessels coated with SiOₓ coating+OMCTS pH protective coating. The vessels are 5 mL vials (the vials are normally filled with product to 5 mL; their capacity without headspace, when capped, is about 7.5 mL) composed of cyclic olefin co-polymer (COC, Topas® 6013M-07).

Sixty vessels are coated on their interior surfaces with an SiOₓ coating produced in a plasma enhanced chemical vapor deposition (PECVD) process using a HMDSO precursor gas according to the Protocol for Coating Tube Interior with SiOₓ set forth above, except that equipment suitable for coating a vial is used. The following conditions are used.
HMDSO flow rate: 0.47 sccm
Oxygen flow rate: 7.5 sccm
RF power: 70 Watts
Coating time: 12 seconds (includes a 2-sec RF power ramp-up time)

Next the SiOₓ coated vials are coated over the SiOₓ with an SiOₓC_{y} coating produced in a PECVD process using an OMCTS precursor gas according to the Protocol for Coating COC Syringe Barrel Interior with OMCTS pH Protective Coating set forth above, except that the same coating equipment is used as for the SiOₓ coating. Thus, the special adaptations in the protocol for coating a syringe are not used. The following conditions are used.
OMCTS flow rate: 2.5 sccm
Argon flow rate: 10 sccm
Oxygen flow rate: 0.7 sccm
RF power: 3.4 Watts
Coating time: 5 seconds

Eight vials are selected and the total deposited quantity of PECVD coating (SiOₓ+SiOₓC_{y}) is determined with a Perkin Elmer Optima Model 7300DV ICP-OES instrument, using the Protocol for Total Silicon Measurement set forth above. This measurement determines the total amount of silicon in both coatings, and does not distinguish between the respective SiOₓ and SiOₓC_{y} coatings. The results are shown below.

Quantity of SiOₓ + pH Protective layer on Vials

| Vial | Total Silicon ug/L |
|---|---|
| 1 | 13844 |
| 2 | 14878 |
| 3 | 14387 |
| 4 | 13731 |
| 5 | 15260 |
| 6 | 15017 |
| 7 | 15118 |
| 8 | 12736 |
| Mean | 14371 |
| StdDev | 877 |

In the following work, except as indicated otherwise in this example, the Protocol for Determining Average Dissolution Rate is followed. Two buffered pH test solutions are used in the remainder of the experiment, respectively at pH 4 and pH 8 to test the effect of pH on dissolution rate. Both test solutions are 50 mM buffers using potassium phosphate as the buffer, diluted in water for injection (WFI) (0.1 um sterilized, filtered). The pH is adjusted to pH 4 or 8, respectively, with concentrated nitric acid.

25 vials are filled with 7.5 ml per vial of pH 4 buffered test solution and 25 other vials are filled with 7.5 ml per vial of pH 4 buffered test solution (note the fill level is to the top of the vial—no head space). The vials are closed using prewashed butyl stoppers and aluminum crimps. The vials at each pH are split into two groups. One group at each pH containing 12 vials is stored at 4° C. and the second group of 13 vials is stored at 23° C.

The vials are sampled at Days 1, 3, 6, and 8. The Protocol for Measuring Dissolved Silicon in a Vessel is used, except as otherwise indicated in this example. The analytical result is reported on the basis of parts per billion of silicon in the buffered test solutions of each vial. A dissolution rate is calculated in terms of parts per billion per day as described above in the Protocol for Determining Average Dissolution Rate. The results at the respective storage temperatures follow. Note that the “Lubricity Coating” identified on the tables below is also functional as a pH protective coating.

| | Shelf Life Conditions 23° C. | |
|---|---|---|
| | Vial SiOx + Lubricity | Vial SiOx + Lubricity |
| | Coating at pH 4 | Coating at pH 8 |
| Si Dissolution Rate | 31 | 7 |
| (PPB/day) | | |

| | Shelf Life Conditions 4° C. | |
|---|---|---|
| | Vial SiOx + Lubricity | Vial SiOx + Lubricity |
| | Coating at pH 4 | Coating at pH 8 |
| Si Dissolution Rate | 7 | 11 |
| (PPB/day) | | |

The observations of Si dissolution versus time for the OMCTS-based coating at pH 8 and pH 4 indicate the pH 4 rates are higher at ambient conditions. Thus, the pH 4 rates are used to determine how much material would need to be initially applied to leave a coating of adequate thickness at the end of the shelf life, taking account of the amount of the initial coating that would be dissolved. The results of this calculation are:

Shelf Life Calculation

| | Vial |
|---|---|
| | with SiOx + Lubricity |
| | Coating at pH 4 |
| Si Dissolution Rate (PPB/day) | 31 |
| Mass of Coating Tested (Total Si) | 14,371 |
| Shelf Life (days) at 23° C. | 464 |
| Shelf Life (years) at 23° C. | 1.3 |
| Required Mass of Coating (Total Si) -- 2-years | 22,630 |
| Required Mass of Coating (Total Si) -- 3-years | 33,945 |

Based on this calculation, the OMCTS pH protective layer, which is the reported “lubricity” layer, needs to be about 2.5 times thicker—resulting in dissolution of 33945 ppb versus the 14,371 ppb representing the entire mass of coating tested—to achieve a 3-year calculated shelf life.

### Example CC

The results of Comparative Example AA and Example BB above can be compared as follows, where the “lubricity layer” is the coating of SiOₓC_{y} referred to in Example BB.

| | Shelf Life Conditions -- | |
|---|---|---|
| | pH 8 and 23° C. | |
| | Vial | Vial with SiOx + Lubricity |
| | with SiOx | Coating |
| Si Dissolution Rate (PPB/day) | 1,250 | 7 |

This data shows that the silicon dissolution rate of SiOₓ alone is reduced by more than 2 orders of magnitude at pH 8 in vials also coated with SiOₓC_{y} coatings.

Another comparison is shown by the following data from several different experiments carried out under similar accelerated dissolution conditions, of which the 1-day data is also presented in FIG. 18.

| | Silicon Dissolution with pH 8 at 40° C. | | | | | | |
|---|---|---|---|---|---|---|---|
| Vial Coating | (ug/L) | | | | | | |
| Description | 1 day | 2 days | 3 days | 4 days | 7 days | 10 days | 15 days |
| A. SiOₓ made with | 165 | 211 | 226 | 252 | 435 | 850 | 1,364 |
| HMDSO Plasma + | | | | | | | |
| Si_{w}OₓC_{y} or its | | | | | | | |
| equivalent SiOₓC_{y} | | | | | | | |
| made with OMCTS | | | | | | | |
| Plasma | | | | | | | |
| B. Si_{w}OₓC_{y} or its | 109 | 107 | 76 | 69 | 74 | 158 | 198 |
| equivalent SiOₓC_{y} | | | | | | | |
| made with OMCTS | | | | | | | |
| Plasma | | | | | | | |
| C. SiOₓ made with | 2,504 | 4,228 | 5,226 | 5,650 | 9,292 | 10,177 | 9,551 |
| HMDSO Plasma | | | | | | | |
| D. SiOₓ made with | 1,607 | 1,341 | 3,927 | 10,182 | 18,148 | 20,446 | 21,889 |
| HMDSO Plasma + | | | | | | | |
| Si_{w}OₓC_{y} or its | | | | | | | |
| equivalent SiOₓC_{y} | | | | | | | |
| made with | | | | | | | |
| HMDSO Plasma | | | | | | | |
| E. Si_{w}OₓC_{y} or its | 1,515 | 1,731 | 1,813 | 1,743 | 2,890 | 3,241 | 3,812 |
| equivalent SiOₓC_{y} | | | | | | | |
| made with | | | | | | | |
| HMDSO Plasma | | | | | | | |

FIG. 18 and Row A (SiOₓ with OMCTS coating) versus C (SiOₓ without OMCTS coating) show that the OMCTS pH protective layer is an effective passivation layer or pH protective coating to the SiOₓ coating at pH 8. The OMCTS coating reduced the one-day dissolution rate from 2504 ug/L (“u” or p or the Greek letter “mu” as used herein are identical, and are all abbreviations for “micro”) to 165 ug/L. This data also shows that an HMDSO-based Si_{w}OₓC_{y} (or its equivalent SiOₓC_{y}) overcoat (Row D) provided a far higher dissolution rate than an OMCTS-based Si_{w}OₓC_{y} (or its equivalent SiOₓC_{y}) overcoat (Row A). This data shows that a substantial benefit can be obtained by using a cyclic precursor versus a linear one, in some embodiments.

### Example DD

Samples 1-6 as listed in Table 9 were prepared as described in Example AA, with further details as follows.

A cyclic olefin copolymer (COC) resin was injection molded to form a batch of 5 ml vials. Silicon chips were adhered with double-sided adhesive tape to the internal walls of the vials. The vials and chips were coated with a two layer coating by plasma enhanced chemical vapor deposition (PECVD). The first layer was composed of SiOₓ with barrier coating or layer properties as defined in the present disclosure, and the second layer was an SiOₓC_{y} pH protective coating.

A precursor gas mixture comprising OMCTS, argon, and oxygen was introduced inside each vial. The gas inside the vial was excited between capacitively coupled electrodes by a radio-frequency (13.56 MHz) power source as described in connection with FIGS. 4-6. The monomer flow rate (Fₘ) in units of sccm, oxygen flow rate (Fₒ) in units of sccm, argon flowrate in sccm, and power (W) in units of watts are shown in Table 9.

A composite parameter, W/FM in units of kJ/kg, was calculated from process parameters W, Fₘ, Fₒ and the molecular weight, M in g/mol, of the individual gas species. W/FM is defined as the energy input per unit mass of polymerizing gases. Polymerizing gases are defined as those species that are incorporated into the growing coating such as, but not limited to, the monomer and oxygen. Non-polymerizing gases, by contrast, are those species that are not incorporated into the growing coating, such as but not limited to argon, helium and neon.

In this test, PECVD processing at high W/FM is believed to have resulted in higher monomer fragmentation, producing organosiloxane coatings with higher cross-link density. PECVD processing at low W/FM, by comparison, is believed to have resulted in lower monomer fragmentation producing organosiloxane coatings with a relatively lower cross-link density.

The relative cross-link density of samples 5, 6, 2, and 3 was compared between different coatings by measuring FTIR absorbance spectra. The spectra of samples 5, 6, 2, and 3 are provided in FIGS. 21-24. In each spectrum, the ratio of the peak absorbance at the symmetric stretching mode (1000-1040 cm⁻¹) versus the peak absorbance at the asymmetric stretching mode (1060-1100 cm⁻¹) of the Si—O—Si bond was measured, and the ratio of these two measurements was calculated, all as shown in Table 9. The respective ratios were found to have a linear correlation to the composite parameter W/FM as shown in FIGS. 19 and 20.

A qualitative relation—whether the coating appeared oily (shiny, often with irridescence) or non-oily (non-shiny) when applied on the silicon chips—was also found to correlate with the W/FM values in Table 9. Oily appearing coatings deposited at lower W/FM values, as confirmed by Table 9, are believed to have a lower crosslink density, as determined by their lower sym/asym ratio, relative to the non-oily coatings that were deposited at higher W/FM and a higher cross-link density. The only exception to this general rule of thumb was sample 2 in Table 9. It is believed that the coating of sample 2 exhibited a non-oily appearance because it was too thin to see. Thus, an oilyness observation was not reported in Table 9 for sample 2. The chips were analyzed by FTIR in transmission mode, with the infrared spectrum transmitted through the chip and sample coating, and the transmission through an uncoated null chip subtracted.

Non-oily organosiloxane layers produced at higher W/FM values, which protect the underlying SiOₓ coating from aqueous solutions at elevated pH and temperature, were preferred because they provided lower Si dissolution and a longer shelf life, as confirmed by Table 9. For example, the calculated silicon dissolution by contents of the vial at a pH of 8 and 40° C. was reduced for the non-oily coatings, and the resulting shelf life was 1381 days in one case and 1147 days in another, as opposed to the much shorter shelf lives and higher rates of dissolution for oily coatings. Calculated shelf life was determined as shown for Example AA. The calculated shelf life also correlated linearly to the ratio of symmetric to asymmetric stretching modes of the Si—O—Si bond in organosiloxane passivation layers or pH protective coatings.

Sample 6 can be particularly compared to Sample 5. An organosiloxane, pH passivation layer or pH protective coating was deposited according to the process conditions of sample 6 in Table 9. The coating was deposited at a high W/FM. This resulted in a non-oily coating with a high Si—O—Si sym/asym ratio of 0.958, which resulted in a low rate of dissolution of 84.1 ppb/day (measured by the Protocol for Determining Average Dissolution Rate) and long shelf life of 1147 days (measured by the Protocol for Determining Calculated Shelf Life). The FTIR spectra of this coating is shown in FIG. 35, which exhibits a relatively similar asymmetric Si—O—Si peak absorbance compared to the symmetric Si—O—Si peak absorbance. This is an indication of a higher cross-link density coating, which is a preferred characteristic for pH protection and long shelf life.

An organosiloxane pH protective coating was deposited according to the process conditions of sample 5 in Table 9. The coating was deposited at a moderate W/FM. This resulted in an oily coating with a low Si—O—Si sym/asym ratio of 0.673, which resulted in a high rate of dissolution of 236.7 ppb/day (following the Protocol for Determining Average Dissolution Rate) and shorter shelf life of 271 days (following the Protocol for Determining Calculated Shelf Life). The FTIR spectrum of this coating is shown in FIG. 21, which exhibits a relatively high asymmetric Si—O—Si peak absorbance compared to the symmetric Si—O—Si peak absorbance. This is an indication of a lower cross-link density coating, which is contemplated to be an unfavorable characteristic for pH protection and long shelf life.

Sample 2 can be particularly compared to Sample 3. A passivation layer or pH protective coating was deposited according to the process conditions of sample 2 in Table 9. The coating was deposited at a low W/FM. This resulted in a coating that exhibited a low Si—O—Si sym/asym ratio of 0.582, which resulted in a high rate of dissolution of 174 ppb/day and short shelf life of 107 days. The FTIR spectrum of this coating is shown in FIG. 36, which exhibits a relatively high asymmetric Si—O—Si peak absorbance compared to the symmetric Si—O—Si peak absorbance. This is an indication of a lower cross-link density coating, which is an unfavorable characteristic for pH protection and long shelf life.

An organosiloxane, pH passivation layer or pH protective coating was deposited according to the process conditions of sample 3 in Table 9. The coating was deposited at a high W/FM. This resulted in a non-oily coating with a high Si—O—Si sym/asym ratio of 0.947, which resulted in a low rate of Si dissolution of 79.5 ppb/day (following the Protocol for Determining Average Dissolution Rate) and long shelf life of 1381 days (following the Protocol for Determining Calculated Shelf Life). The FTIR spectrum of this coating is shown in FIG. 37, which exhibits a relatively similar asymmetric Si—O—Si peak absorbance compared to the symmetric Si—O—Si peak absorbance. This is an indication of a higher cross-link density coating, which is a preferred characteristic for pH protection and long shelf life.

### Example EE

An experiment similar to Example BB was carried out, modified as indicated in this example and in Table 10 (where the results are tabulated). 100 5 mL COP vials were made and coated with an SiOₓ barrier coating or layer and an OMCTS-based passivation layer or pH protective coating as described previously, except that for Sample PC194 only the passivation layer or pH protective coating was applied. The coating quantity was again measured in parts per billion extracted from the surfaces of the vials to remove the entire passivation layer or pH protective coating, as reported in Table 10.

In this example, several different coating dissolution conditions were employed. The test solutions used for dissolution contained either 0.02 or 0.2 wt. % polysorbate-80 surfactant, as well as a buffer to maintain a pH of 8. Dissolution tests were carried out at either 23° C. or 40° C.

Multiple syringes were filled with each test solution, stored at the indicated temperature, and analyzed at several intervals to determine the extraction profile and the amount of silicon extracted. An average dissolution rate for protracted storage times was then calculated by extrapolating the data obtained according to the Protocol for Determining Average Dissolution Rate. The results were calculated as described previously and are shown in Table 10. Of particular note, as shown on Table 10, were the very long calculated shelf lives of the filled packages provided with a PC 194 passivation layer or pH protective coating:

21045 days (over 57 years) based on storage at a pH of 8, 0.02 wt. % polysorbate-80 surfactant, at 23° C.;

38768 days (over 100 years) based on storage at a pH of 8, 0.2 wt. % polysorbate-80 surfactant, at 23° C.;

8184 days (over 22 years) based on storage at a pH of 8, 0.02 wt. % polysorbate-80 surfactant, at 40° C.; and

14732 days (over 40 years) based on storage at a pH of 8, 0.2 wt. % polysorbate-80 surfactant, at 40° C.

Referring to Table 10, the longest calculated shelf lives corresponded with the use of an RF power level of 150 Watts and a corresponding high W/FM value. It is believed that the use of a higher power level causes higher cross-link density of the passivation layer or pH protective coating.

### Example FF

Another series of experiments similar to those of Example EE are run, showing the effect of progressively increasing the RF power level on the FTIR absorbance spectrum of the passivation layer or pH protective coating. The results are tabulated in Table 11, which in each instance shows a symmetric/assymmetric ratio greater than 0.75 between the maximum amplitude of the Si—O—Si symmetrical stretch peak normally located between about 1000 and 1040 cm⁻¹, and the maximum amplitude of the Si—O—Si assymmetric stretch peak normally located between about 1060 and about 1100 cm⁻¹. Thus, the symmetric/assymmetric ratio is 0.79 at a power level of 20 W, 1.21 or 1.22 at power levels of 40, 60, or 80 W, and 1.26 at 100 Watts under otherwise comparable conditions.

The 150 Watt data in Table 11 is taken under somewhat different conditions than the other data, so it is not directly comparable with the 20-100 Watt data discussed above. The FTIR data of samples 6 and 8 of Table 11 was taken from the upper portion of the vial and the FTIR data of samples 7 and 9 of Table 11 was taken from the lower portion of the vial. Also, the amount of OMCTS was cut in half for samples 8 and 9 of Table 11, compared to samples 6 and 7. Reducing the oxygen level while maintaining a power level of 150 W raised the symmetric/asymmetric ratio still further, as shown by comparing samples 6 and 7 to samples 8 and 9 in Table 11.

It is believed that, other conditions being equal, increasing the symmetric/asymmetric ratio increases the shelf life of a vessel filled with a material having a pH exceeding 5.

Table 12 shows the calculated O-Parameters and N-Parameters (as defined in U.S. Pat. No. 8,067,070) for the experiments summarized in Table 11. As Table 12 shows, the O-Parameters ranged from 0.134 to 0.343, and the N-Parameters ranged from 0.408 to 0.623—all outside the ranges claimed in U.S. Pat. No. 8,067,070.

### Example GG

### Measurement of Contact Angle

The test purpose was to determine the contact angle or surface energy on the inside surface of two kinds of plastic vials and one kind of glass vial.

The specimens that underwent testing and analysis reported here are three kinds of vials. The specimens are (A) an uncoated COP vial, (B) an SiOₓ+passivation layer or pH protective coating on a COP vial prepared according to the above Protocol for Coating Syringe Barrel Interior with SiOₓ, followed by the Protocol for Coating Syringe Barrel Interior with OMCTS Passivation layer or pH protective coating, and (C) a glass vial. Small pieces were obtained by cutting the plastic vials or crushing the glass vial in order to test the inside surface.

The analysis instrument for the contact angle tests is the Contact Angle Meter model DM-701, made by Kyowa Interface Science Co., Ltd. (Tokyo, Japan). To obtain the contact angle, five water droplets were deposited on the inside surface of small pieces obtained from each specimen. The testing conditions and parameters are summarized below. Both plastic vials were cut and trimmed, while the glass vial needed to be crushed. The best representative pieces for each specimen were selected for testing. A dropsize of 1 μL (one microliter) was used for all samples. Due to the curvature of the specimens, a curvature correction routine was used to accurately measure the contact angle. The second table below contains the values for the radius of curvature used for each specimen.

Contact Angle Testing Conditions and Parameters

| | |
|---|---|
| Test instrument | DM-701 Contact Angle Meter |
| Liquid Dispenser | 22 gauge stainless steel needle |
| Drop Size | 1 μL |
| Test liquid | Distilled water |
| Environment | Ambient air, room temperature |

Radius of Curvature for each Vial Specimen

| | Radius of Curvature |
|---|---|
| Specimen | (μm, micrometers) |
| COP | 9240 |
| COP plus passivation layer or | 9235 |
| pH protective coating | |
| Glass | 9900 |

The contact angle results for each specimen are provided below.

The specimen made from COP plus passivation layer or pH protective coating had the highest average contact angle of all tested specimens. The average contact angle for specimen made from COP plus passivation layer or pH protective coating was 99.1°. The average contact angle for the uncoated COP specimen was 90.5°. The glass specimen had a significantly lower average contact angle at 10.6°. This data shows the utility of the pH protective coating to raise the contact angle of the uncoated COP vessel. It is expected that an SiOₓ coated vessel without the passivation layer or pH protective coating would exhibit a result similar to glass, which shows a hydrophilic coating relative to the relative to the passivation layer or pH protective coating.

TABLE
Contact Angle Results for Each Tested Specimen (degrees)

| | | | | | | | Std. |
|---|---|---|---|---|---|---|---|
| Specimen | Test 1 | Test 2 | Test 3 | Test 4 | Test 5 | Ave. | Dev. |
| COP | 88.9 | 91.9 | 89.1 | 91.4 | 91.1 | 90.5 | 1.4 |
| COP/Pass. | 98.9 | 96.8 | 102.2 | 98.3 | 99.5 | 99.1 | 2.0 |
| Glass | 11.6 | 10.6 | 10.1 | 10.4 | 10.4 | 10.6 | 0.6 |

Note:
“Pass.” means passivation layer or pH protective coating.

### Example HH—

The purpose of this example was to evaluate the recoverability or drainage of a slightly viscous aqueous solution from glass, COP and coated vials,

This study evaluated the recovery of a 30 cps (centipoise) carbohydrate solution in water-for-injection from (A) an uncoated COP vial, (B) an SiOₓ+passivation layer or pH protective coating on a COP vial prepared according to the above Protocol for Coating Syringe Barrel Interior with SiOₓ, followed by the Protocol for Coating Syringe Barrel Interior with OMCTS Passivation layer or pH protective coating, and (C) a glass vial.

2.0 ml of the carbohydrate solution was pipetted into 30 vials each of glass, COP and vials coated with a passivation layer or pH protective coating. The solution was aspirated from the vials with a 10 ml syringe, through a 23 gauge, 1.5″ needle. The vials were tipped to one side as the solution was aspirated to maximize the amount recovered. The same technique and similar withdrawal time was used for all vials. The vials were weighed empty, after placing 2.0 ml of the solution to the vial and at the conclusion of aspirating the solution from the vial. The amount delivered to the vial (A) was determined by subtracting the weight of the empty vial from the weight of the vial with the 2.0 ml of solution. The weight of solution not recovered (B) was determined by subtracting the weight of the empty vial from the weight of the vials after aspirating the solution from the vial. The percent unrecovered was determined by dividing B by A and multiplying by 100.

It was observed during the aspiration of drug product that the glass vials remained wetted with the solution. The COP vial repelled the liquid and as the solution was aspirated from the vials. This helped with recovery but droplets were observed to bead on the sidewalls of the vials during the aspiration. The vials coated with a pH protective coating also repelled the liquid during aspiration but no beading of solution on the sidewalls was observed.

The conclusion was that vials coated with a pH protective coating do not wet with aqueous solutions as do glass vials, leading to superior recovery of fluid contents, such as a drug product or analytical sample, relative to glass. Vials coated with a passivation layer or pH protective coating were not observed to cause beading of solution on sidewall during aspiration of aqueous products therefore coated vials performed better than uncoated COP vials in product recovery experiments.

### Example II

### Measurement of Contact Angle

The test purpose was to determine the contact angle or surface energy on the inside surface of two kinds of plastic vials and one kind of glass vial

The specimens that underwent testing and analysis reported here are three kinds of vials. The specimens are (A) an uncoated COP vial, (B) an SiOₓ+pH protective layer coated COP vial prepared according to the above Protocol for Coating Syringe Barrel Interior with SiOₓ, followed by the Protocol for Coating Syringe Barrel Interior with OMCTS PH protective Coating or Layer, and (C) a glass vial. Small pieces were obtained by cutting the plastic vials or crushing the glass vial in order to test the inside surface.

The analysis instrument for the contact angle tests is the Contact Angle Meter model DM-701, made by Kyowa Interface Science Co., Ltd. (Tokyo, Japan). To obtain the contact angle, five water droplets were deposited on the inside surface of small pieces obtained from each specimen. The testing conditions and parameters are summarized below. Both plastic vials were cut and trimmed, while the glass vial needed to be crushed. The best representative pieces for each specimen were selected for testing. A dropsize of 1 μL (one microliter) was used for all samples. Due to the curvature of the specimens, a curvature correction routine was used to accurately measure the contact angle. The second table below contains the values for the radius of curvature used for each specimen.

Contact Angle Testing Conditions and Parameters

| | |
|---|---|
| Test instrument | DM-701 Contact Angle Meter |
| Liquid Dispenser | 22 gauge stainless steel needle |
| Drop Size | 1 μL |
| Test liquid | Distilled water |
| Environment | Ambient air, room temperature |

Radius of Curvature for each Vial Specimen

| | Radius of Curvature |
|---|---|
| Specimen | (μm, micrometers) |
| COP | 9240 |
| COP plus pH protective | 9235 |
| Glass | 9900 |

The contact angle results for each specimen are provided below.

The COP plus pH protective coated specimen had the highest average contact angle of all tested specimens. The average contact angle for the COP plus pH protective coating or layer specimen was 99.1°. The average contact angle for the uncoated COP specimen was 90.5°. The glass specimen had a significantly lower average contact angle at 10.6°. This data shows the utility of the pH protective coating to raise the contact angle of the uncoated COP vessel. It is expected that an SiOₓ coated vessel without the pH protective coating or layer would exhibit a result similar to glass, which shows a hydrophilic coating relative to the pH protective coating or layer.

TABLE 3
Contact Angle Result for Each Tested Specimen (degrees)

| | | | | | | | Std. |
|---|---|---|---|---|---|---|---|
| Specimen | Test 1 | Test 2 | Test 3 | Test 4 | Test 5 | Ave | Dev. |
| COP | 88.9 | 91.9 | 89.1 | 91.4 | 91.1 | 90.5 | 1.4 |
| COP/PH | 98.9 | 96.8 | 102.2 | 98.3 | 99.5 | 99.1 | 2.0 |
| protective | | | | | | | |
| Glass | 11.6 | 10.6 | 10.1 | 10.4 | 10.4 | 10.6 | 0.6 |

One of the optional embodiments of the present invention is a syringe part, for example a syringe barrel or plunger tip, coated with a deposit of lubricant on a pH protective coating or layer. In this contemplated embodiment, the relevant static frictional resistance in the context of the present invention is the breakout force as defined herein, and the relevant kinetic frictional resistance in the context of the present invention is the plunger sliding force as defined herein. For example, the plunger sliding force as defined and determined herein is suitable to determine the presence or absence and the lubricity and/or protective characteristics of a deposit of lubricant on a pH protective coating or layer in the context of the present invention whenever the coating or layer is applied to any syringe or syringe part, for example to the inner wall of a syringe barrel. The breakout force is of particular relevance for evaluation of the coating or layer effect on a prefilled syringe, i.e. a syringe which is filled after coating and can be stored for some time, for example several months or even years, before the plunger tip is moved again (has to be “broken out”).

### Example JJ—

The purpose of this example was to evaluate the recoverability or drainage of a slightly viscous aqueous solution from glass, COP and coated vials,

This study evaluated the recovery of a 30 cps (centipoise) carbohydrate solution in water-for-injection from (A) an uncoated COP vial, (B) an SiOₓ+pH protective layer coated COP vial prepared according to the above Protocol for Coating Syringe Barrel Interior with SiOₓ, followed by the Protocol for Coating Syringe Barrel Interior with OMCTS PH protective Coating or Layer, and (C) a glass vial.

2.0 ml of the carbohydrate solution was pipetted into 30 vials each of glass, COP and pH protective coated vials. The solution was aspirated from the vials with a 10 ml syringe, through a 23 gauge, 1.5″ needle. The vials were tipped to one side as the solution was aspirated to maximize the amount recovered. The same technique and similar withdrawal time was used for all vials. The vials were weighed empty, after placing 2.0 ml of the solution to the vial and at the conclusion of aspirating the solution from the vial. The amount delivered to the vial (A) was determined by subtracting the weight of the empty vial from the weight of the vial with the 2.0 ml of solution. The weight of solution not recovered (B) was determined by subtracting the weight of the empty vial from the weight of the vials after aspirating the solution from the vial. The percent unrecovered was determined by dividing B by A and multiplying by 100.

It was observed during the aspiration of drug product that the glass vials remained wetted with the solution. The COP vial repelled the liquid and as the solution was aspirated from the vials. This helped with recovery but droplets were observed to bead on the sidewalls of the vials during the aspiration. The pH protective coated vials also repelled the liquid during aspiration but no beading of solution on the sidewalls was observed.

The conclusion was that pH protective coated vials do not wet with aqueous solutions as do glass vials, leading to superior recovery of drug product relative to glass. PH protective coated vials were not observed to cause beading of solution on sidewall during aspiration of aqueous products therefore coated vials performed better than uncoated COP vials in product recovery experiments.

TABLE 1
PLUNGER SLIDING FORCE MEASUREMENTS OF OMCTS-BASED PLASMA
PASSIVATION LAYER OR PH PROTECTIVE COATING MADE WITH CARRIER GAS

| | | | | | | Carrier | | | | | |
|---|---|---|---|---|---|---|---|---|---|---|---|
| | | | | | | Gas | | | | | |
| | pH | | | OMCTS | | (Ar) | | | | | |
| | protective | | Coating | Flow | O2 Flow | Flow | | Initiation | | Maintenance | |
| | coating | | Time | Rate | Rate | Rate | Power | Force, Fᵢ | | Force, Fₘ | |
| Example | Type | Monomer | (sec) | (sccm) | (sccm) | (sccm) | (Watts) | (N, Kg.) | | (N, Kg.) | |
| A | Uncoated | n/a | n/a | n/a | n/a | n/a | n/a | >11 | N | >11 | N |
| (Control) | COC | | | | | | | >1.1 | Kg. | >1.1 | Kg. |
| B | Silicone oil | n/a | n/a | n/a | n/a | n/a | n/a | 8.2 | N | 6.3 | N |
| (Industry | on COC | | | | | | | 0.84 | Kg. | 0.64 | Kg. |
| Standard) | | | | | | | | | | | |
| C | L3 lubricity | OMCTS | 10 sec | 3 | 0 | 65 | 6 | 4.6 | N | 4.6 | N |
| (without | coating or | | | | | | | 0.47 | Kg. | 0.47 | Kg. |
| Oxygen) | layer over | | | | | | | | | | |
| | SiOₓ on | | | | | | | | | | |
| | COC | | | | | | | | | | |
| D | L2 pH | OMCTS | 10 sec | 3 | 1 | 65 | 6 | 4.8 | N | 3.5 | N |
| (with | protective | | | | | | | 0.49 | Kg. | 0.36 | Kg. |
| Oxygen) | coating | | | | | | | | | | |
| | over SiOₓ | | | | | | | | | | |
| | on COC | | | | | | | | | | |

TABLE 2
OMCTS pH protective coating (E and F)

| | | | | Initiation | Maintenance | ICPMS | |
|---|---|---|---|---|---|---|---|
| | OMCTS | O₂ | Ar | Force, Fᵢ | Force, | (μg./ | ICPMS |
| Example | (sccm) | (sccm) | (sccm) | (N) | Fₘ (N) | liter) | Mode |
| E | 3.0 | 0.38 | 7.8 | 4.8 | 3.5 | <5 | static |
| F | 3.0 | 0.38 | 7.8 | 5.4 | 4.3 | 38 | dynamic |
| G | n/a | n/a | n/a | 13 | 11 | <5 | static |
| (SiOₓ only) | | | | | | | |
| H | n/a | n/a | n/a | 8.2 | 6.3 | | |
| (silicone | | | | | | | |
| oil) | | | | | | | |

TABLE 3
OMCTS pH protective coating

| | | | | Initiation | Maintenance |
|---|---|---|---|---|---|
| | OMCTS | O₂ | Ar | Force, Fᵢ | Force, |
| Example | (sccm) | (sccm) | (sccm) | (N) | Fₘ (N) |
| I | 2.5 | 0.38 | 7.6 | 5.1 | 4.4 |
| J | 2.5 | 0.38 | — | 7.1 | 6.2 |
| K | 2.5 | — | — | 8.2 | 7.2 |

TABLE 4
HMDSO pH protective coating

| | | | | Initiation | Maintenance |
|---|---|---|---|---|---|
| | HMDSO | O₂ | Ar | Force, Fᵢ | Force, |
| Example | (sccm) | (sccm) | (sccm) | (N) | Fₘ (N) |
| L | 2.5 | 0.38 | 7.6 | 9 | 8.4 |
| M | 2.5 | 0.38 | — | >11 | >11 |
| N | 2.5 | — | — | >11 | >11 |

TABLE 5

| | | | | | | | | SEM | |
|---|---|---|---|---|---|---|---|---|---|
| | | | | | Dep. | | | Micrograph | |
| | | OMCTS | Ar/O₂ | Power | Time | Plunger Force | | (5 micronAF | AFM RMS |
| Example | | (sccm) | (sccm) | (Watts) | (sec) | Fᵢ (lbs, Kg) | Fₘ (lbs, Kg) | Vertical) | (nanometers) |
| O | Baseline | 2.0 | 10/0.38 | 3.5 | 10 | 4.66, 2.11 | 3.47, 1.57 | | |
| | OMCTS pH | | | | | (ave) | (ave) | | |
| P | Prot. | | | | | | | FIG. 10 | |
| Q | | | | | | | | | 19.6, 9.9, 9.4 |
| | | | | | | | | | (Average = 13.0 |
| R | High Power | 2.0 | 10/0.38 | 4.5 | 10 | 4.9, 2.2 | 7.6, 3.4 | | |
| S | OMCTS pH | | | | | | | FIG. 11 | |
| T | Prot. | | | | | | | | 12.5, 8.4, 6.1 |
| | | | | | | | | | (Average = 6.3) |
| U | No O₂ OMCTS | 2.0 | 10/0 | 3.4 | 10 | 4.9, 2.2 | 9.7, 4.4 | | |
| | pH prot. | | | | | | (stopped) | | |
| V | | | | | | | | | 1.9, 2.6, 3.0 |
| | | | | | | | | | (Average = 2.3) |

TABLE 6

| | | | | Siloxane | | Power | Dep. Time | Fᵢ (lb., | Fₘ (lb., |
|---|---|---|---|---|---|---|---|---|---|
| | SiOₓ/Lub | Coater | Mode | Feed | Ar/O₂ | (W) | (Sec.) | Kg.) | Kg.) |
| Example W | SiOₓ: | Auto-Tube | Auto | HMDSO | 0 sccm Ar, | 37 | 7 | ~ | ~ |
| SiOₓ/Baseline | | | | 52.5 in, | 90 sccm O₂ | | | | |
| OMCTS Lub | | | | 133.4 cm. | | | | | |
| | pH Protect.: | Auto-S | same | OMCTS, | 10 sccm Ar | 3.4 | 10 | 2.9, 1.3 | 3.3, 1.5 |
| | | | | 2.0 sccm | 0.38 sccm O₂ | | | | |
| Example X | SiOₓ: | same | same | same | same | 37 | 7 | ~ | ~ |
| SiOₓ/High Pwr | pH Protect. | same | same | same | same | 4.5 | 10 | 5, 2.3 | 9.5, 4.3 |
| OMCTS Lub | | | | | | | | | stopped |
| Example Y | SiOₓ: | Auto-Tube | same | same | 0 sccm Ar, | 37 | 7 | ~ | ~ |
| SiOₓ/No O₂ | | | | | 90 sccm O₂ | | | | |
| OMCTS Lub | pH Protect. | Auto-S | same | same | 10 sccm Ar | 3.4 | 10 | 5.6, | 9.5, 4.3 |
| | | | | | 0 sccm O₂ | | | | stopped |

TABLE 7
Silicon Extractables Comparison of Lubricity Coatings

| Package Type | Static (ug/L) | Dynamic (ug/L) |
|---|---|---|
| Cyclic Olefin Syringe with CV | 70 | 81 |
| Holdings SiOCH Lubricity Coating | | |
| Borocilicate Glass Syringe | 825 | 835 |
| with silicone oil | | |

TABLE 8
Summary Table of OMCTS pH protective coating from Tables 1, 2, 3 and 5

| | OMCTS | | | | Dep Time | | |
|---|---|---|---|---|---|---|---|
| Example | (sccm) | O₂ (sccm) | Ar (sccm) | Power (Watt) | (sec) | Fᵢ (lbs) | Fₘ (lbs) |
| C | 3.0 | 0.00 | 65 | 6 | 10 | 1.0 | 1.0 |
| D | 3.0 | 1.00 | 65 | 6 | 10 | 1.1 | 0.8 |
| E | 3.0 | 0.38 | 7.8 | 6 | 10 | 0.8 | 1.1 |
| F | 3.0 | 0.38 | 7.8 | 6 | 10 | 1.2 | 1.0 |
| I | 2.5 | 0.38 | 7.6 | 6 | 10 | 1.1 | 1.0 |
| J | 2.5 | 0.38 | 0.0 | 6 | 10 | 1.6 | 1.4 |
| K | 2.5 | 0.00 | 0.0 | 6 | 10 | 1.8 | 1.6 |
| O | 2.0 | 0.38 | 10 | 3.5 | 10 | 4.6 | 3.5 |
| R | 2.0 | 0.38 | 10 | 4.5 | 10 | 4.9 | 7.6 |
| U | 2.0 | 0.00 | 10 | 3.4 | 10 | 4.9 | 9.7 (stop) |
| W | 2.0 | 0.38 | 10 | 3.4 | 10 | 2.9 | 3.3 |
| X | 2.0 | 0.38 | 10 | 4.5 | 10 | 5.0 | 9.5 (stop) |
| Y | 2.0 | 0.00 | 10 | 3.4 | 10 | 5.6 | 9.5 (stop) |

TABLE 9

| | | | | | | | | | FTIR Absorbance | | | |
|---|---|---|---|---|---|---|---|---|---|---|---|---|
| | Process Parameters | | | | | Si Dissolution @ pH8/40° C. | | | | | Ratio | |
| Flow | | | O₂ | | | | Shelf | Rate of | Si—O—Si sym | Si—O—Si | Si—O—Si | |
| Rate | | | Flow | Power | W/FM | Total Si | life | Dissolution | stretch | asym stretch | (sym/ | |
| Samples | OMCTS | Ar | Rate | (W) | (kJ/kg) | (ppb) | (days) | (ppb/day) | (1000-1040 cm⁻¹) | (1060-1100 cm⁻¹) | asym) | Oilyness |
| 1 | 3 | 10 | 0.5 | 14 | 21613 | 43464 | 385 | 293.18 | 0.153 | 0.219 | 0.700 | YES |
| 2 | 3 | 20 | 0.5 | 2 | 3088 | 7180 | 107 | 174.08 | 0.011 | 0.020 | 0.582 | NA |
| 3 | 1 | 20 | 0.5 | 14 | 62533 | 42252.17 | 1381 | 79.53 | 0.093 | 0.098 | 0.947 | NO |
| 4 | 2 | 15 | 0.5 | 8 | 18356 | 27398 | 380 | 187.63 | 0.106 | 0.141 | 0.748 | YES |
| 5 | 3 | 20 | 0.5 | 14 | 21613 | 24699 | 271 | 236.73 | 0.135 | 0.201 | 0.673 | YES |
| 6 | 1 | 10 | 0.5 | 14 | 62533 | 37094 | 1147 | 84.1 | 0.134 | 0.140 | 0.958 | NO |

TABLE 10

| | OMCTS | Argon | O₂ | | | | Total Si | | Average |
|---|---|---|---|---|---|---|---|---|---|
| | Flow | Flow | Flow | | Plasma | | (ppb) | Calculated | Rate of |
| | Rate | Rate | Rate | Power | Duration | W/FM | (OMCTS) | Shelf-life | Dissolution |
| Sample | (sccm) | (sccm) | (sccm) | (W) | (sec) | (kJ/kg) | layer) | (days) | (ppb/day) |
| | | | | | | | Si Dissolution @ | | |
| | Process Parameters | | | | | | pH8/23° C./0.02% Tween ®-80 | | |
| PC194 | 0.5 | 20 | 0.5 | 150 | 20 | 1223335 | 73660 | 21045 | 3.5 |
| 018 | 1.0 | 20 | 0.5 | 18 | 15 | 77157 | 42982 | 1330 | 32.3 |
| | | | | | | | Si Dissolution @ | | |
| | Process Parameters | | | | | | pH8/23° C./0.2% Tween ®-80 | | |
| PC194 | 0.5 | 20 | 0.5 | 150 | 20 | 1223335 | 73660 | 38768 | 1.9 |
| 018 | 1.0 | 20 | 0.5 | 18 | 15 | 77157 | 42982 | 665 | 64.6 |
| 048 | 4 | 80 | 2 | 35 | 20 | 37507 | 56520 | 1074 | 52.62 |
| | | | | | | | Si Dissolution @ | | |
| | Process Parameters | | | | | | pH8/40° C./0.02% Tween ®-80 | | |
| PC194 | 0.5 | 20 | 0.5 | 150 | 20 | 1223335 | 73660 | 8184 | 9 |
| 018 | 1.0 | 20 | 0.5 | 18 | 15 | 77157 | 42982 | 511 | 84 |
| | | | | | | | Si Dissolution @ | | |
| | Process Parameters | | | | | | pH8/40° C./0.2% Tween ®-80 | | |
| PC194 | 0.5 | 20 | 0.5 | 150 | 20 | 1223335 | 73660 | 14732 | 5 |
| 018 | 1.0 | 20 | 0.5 | 18 | 15 | 77157 | 42982 | 255 | 168 |

TABLE 11

| | OMCTS | Argon | O₂ | | | | Symmetric | Assymetric | |
|---|---|---|---|---|---|---|---|---|---|
| | Flow | Flow | Flow | | Plasma | | Stretch | Stretch | |
| | Rate | Rate | Rate | Power | Duration | W/FM | Peak at | Peak at | Symmetric/Assymetric |
| Samples | (sccm) | (sccm) | (sccm) | (W) | (sec) | (kJ/kg) | 1000-1040 cm⁻¹ | 1060-1100 cm⁻¹ | Ratio |
| ID | Process Parameters | | | | | | FTIR Results | | |
| 1 | 1 | 20 | 0.5 | 20 | 20 | 85,730 | 0.0793 | 0.1007 | 0.79 |
| 2 | 1 | 20 | 0.5 | 40 | 20 | 171,460 | 0.0619 | 0.0507 | 1.22 |
| 3 | 1 | 20 | 0.5 | 60 | 20 | 257,190 | 0.1092 | 0.0904 | 1.21 |
| 4 | 1 | 20 | 0.5 | 80 | 20 | 342,919 | 0.1358 | 0.1116 | 1.22 |
| 5 | 1 | 20 | 0.5 | 100 | 20 | 428,649 | 0.209 | 0.1658 | 1.26 |
| 6 | 1 | 20 | 0.5 | 150 | 20 | 642,973 | 0.2312 | 0.1905 | 1.21 |
| 7 | 1 | 20 | 0.5 | 150 | 20 | 642,973 | 0.2324 | 0.1897 | 1.23 |
| 8 | 0.5 | 20 | 0.5 | 150 | 20 | 1,223,335 | 0.1713 | 0.1353 | 1.27 |
| 9 | 0.5 | 20 | 0.5 | 150 | 20 | 1,223,335 | 0.1475 | 0.1151 | 1.28 |

TABLE 12

| | OMCTS | Argon | O₂ | | | | | |
|---|---|---|---|---|---|---|---|---|
| | Flow | Flow | Flow | | Plasma | | | |
| | Rate | Rate | Rate | Power | Duration | W/FM | | |
| Samples | (sccm) | (sccm) | (sccm) | (W) | (sec) | (kJ/kg) | O- | N- |
| ID | Process Parameters | | | | | | Parameter | Parameter |
| 1 | 1 | 20 | 0.5 | 20 | 20 | 85,730 | 0.343 | 0.436 |
| 2 | 1 | 20 | 0.5 | 40 | 20 | 171,460 | 0.267 | 0.408 |
| 3 | 1 | 20 | 0.5 | 60 | 20 | 257,190 | 0.311 | 0.457 |
| 4 | 1 | 20 | 0.5 | 80 | 20 | 342,919 | 0.270 | 0.421 |
| 5 | 1 | 20 | 0.5 | 100 | 20 | 428,649 | 0.177 | 0.406 |
| 6 | 1 | 20 | 0.5 | 150 | 20 | 642,973 | 0.151 | 0.453 |
| 7 | 1 | 20 | 0.5 | 150 | 20 | 642,973 | 0.151 | 0.448 |
| 8 | 0.5 | 20 | 0.5 | 150 | 20 | 1,223,335 | 0.134 | 0.623 |
| 9 | 0.5 | 20 | 0.5 | 150 | 20 | 1,223,335 | 0.167 | 0.609 |

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A chromatography vial comprising:
a thermoplastic wall having an interior surface (16) defining a sample containment lumen; and
a coating comprising a PECVD barrier coating or layer of SiOx, where x is from 1.5 to 2.9, on the interior surface.

2-3. (canceled)

4. The invention of claim 1, in which the PECVD coating or layer of SiOx is effective to reduce the quantity of extraction of at least one extractable compound in the thermoplastic wall.

5. The invention of claim 1, configured for liquid chromatography (LC) samples, for example high pressure liquid chromatography (HPLC), LC, ultra high pressure liquid chromatography (UHPLC), ultra performance liquid chromatography (UPLC), gas chromatography, Ion-exchanged chromatography, supercritical flow chromatography, or a combination of any two or more of these.

6. The invention of claim 1, in which the coating further comprises a tie coating or layer comprising SiOxCy or SiNxCy, wherein x is from about 0.5 to about 2.4 and y is from about 0.6 to about 3, between the barrier coating or layer and the interior surface.

7. The invention of claim 1, in which the coating further comprises a pH protective coating or layer comprising SiOxCy or SiNxCy, wherein x is from about 0.5 to about 2.4 and y is from about 0.6 to about 3, between the barrier coating or layer and the lumen.

8. The invention of claim 7, in which the rate of erosion of the pH protective coating or layer, if directly contacted by a fluid composition having a pH at some point between 5 and 9, is less than the rate of erosion of the barrier coating or layer, if directly contacted by the fluid composition.

9. The invention of claim 7, in which the pH protective coating or layer and tie coating or layer together are effective to keep the barrier coating or layer at least substantially undissolved as a result of attack by the fluid composition for a period of at least six months.

10. The invention of claim 1, in which the wall comprises a polycarbonate, an olefin polymer (for example polypropylene (PP) or polyethylene (PE)), a cyclic olefin copolymer (COC), a cyclic olefin polymer (COP), polymethylpentene, a polyester (for example polyethylene terephthalate, polyethylene naphthalate, or polybutylene terephthalate (PBT)), PVdC (polyvinylidene chloride), polyvinyl chloride (PVC), polycarbonate, polylactic acid, polystyrene, hydrogenated polystyrene, poly(cyclohexylethylene) (PCHE), epoxy resin, nylon, polyurethane polyacrylonitrile (PAN), polyacrylonitrile (PAN), an ionomeric resin (for example Surlyn®), glass (for example borosilicate glass), or a combination of any two or more of these; preferably comprises a cyclic olefin polymer, a polyethylene terephthalate or a polypropylene; and more preferably comprises COP.

11-23. (canceled)

24. The invention of claim 1 in which the barrier coating or layer on average is between 10 and 200 nm thick.

25. The invention of claim 1 in which the barrier coating or layer on average is between 10 and 100 nm thick.

26-34. (canceled)

35. The invention of claim 1, in which the barrier coating or layer is from 4 nm to 500 nm thick.

36. The invention of claim 1, in which the barrier coating or layer is from 7 nm to 400 nm thick.

37. The invention of claim 1, in which the barrier coating or layer is from 10 nm to 300 nm thick.

38. The invention of claim 1, in which the barrier coating or layer is from 20 nm to 200 nm thick.

39. The invention of claim 1, in which the barrier coating or layer is from 30 nm to 100 nm thick.

40-71. (canceled)

72. The invention of claim 1, having a shelf life, after the invention is assembled, of at least one year.

73. The invention of claim 1, having a shelf life, after the invention is assembled, of at least two years.

74. The invention of claim 1, having a shelf life, after the invention is assembled, of at least three years.

75-210. (canceled)

211. A method of applying a barrier coating of SiOx, in which x is from about 1.5 to about 2.9, on the chromatography vial of claim 1, comprising:
providing a chromatography vial (10) comprising a thermoplastic wall (12) having an interior surface (16) defining a sample containment lumen (20);
providing a reaction mixture (from 110) comprising plasma forming gas, for example an organosilicon compound precursor gas, optionally an oxidizing gas, optionally a carrier or diluent gas, and optionally a hydrocarbon gas;
forming plasma in the reaction mixture by energizing the vicinity of the precursor gas with electrodes supplied with electric power at equal to or more than 5 W/ml. of plasma volume;
contacting the interior surface of the chromatography vial with the reaction mixture; and
depositing the coating of SiOx on at least a portion of the interior surface of the chromatography vial.

212-224. (canceled)
